(19) United States
(12) Patent Application Publication
(10) Pub. No.: US 2013/0006805 A1
(43) Pub. Date: Jan. 3, 2013

(54) Online Marketplace for Collective Buying

(76) Inventor: Balaji Ulli, West Covina, CA (US)

(21) Appl. No.: 13/538,563

(22) Filed: Jun. 29, 2012

Related U.S. Application Data
(60) Provisional application No. 61/504,143, filed on Jul. 1, 2011.

(51) Int. Cl. G06Q 30/06

(52) U.S. Cl. 705/26.8; 705/26.1

(57) ABSTRACT

The present specification is an e-commerce business/system (“System”) that facilitates the sale of goods and/or services between Seller(s) and individual consumers that are affiliates/members of a community group (“Organization”). In addition, the present specification is a System that facilitates formation, identification, aggregation and registration of such Organizations, to help its constituent consumers/members realize cost savings through collective buying opportunities and, optionally, have an opportunity to pledge at least a portion of the cost savings realized through such buying as charitable funds to be donated to the Organization. In addition, the present specification is a System that provides to interested sellers a retail platform for specified periods of time to reach and sell to specific group(s) of consumers who constitute Organizations defined by demographics, socio-economic factors, geographical location and known buying preferences.

### CROSS-REFERENCE TO RELATED APPLICATIONS

The present application claims priority from U.S. Provisional Patent Application 61/504,143, of the same title, and filed on Jul. 1, 2011, which is herein incorporated by reference in its entirety.

### FIELD

The present specification relates to an e-commerce business/system (“System”) that facilitates the sale of goods and/or services between Seller(s) and individual consumers identifying themselves to be affiliates/members of a community group (“Organization”). In addition, the present specification relates to a System that facilitates formation, identification, aggregation and registration of such Organizations, to help its constituent consumers/members realize cost savings through collective buying opportunities and, optionally, have an opportunity to pledge at least a portion of the cost savings realized through such buying as charitable funds to be donated to the Organization. In addition, the present specification relates to a System that provides to interested sellers a retail platform for specified periods of time to reach and sell to specific group(s) of consumers who constitute Organizations defined by demographics, socio-economic factors, geographical location and known buying preferences. In addition, the present specification relates to a system in which an Organization can choose a size and location of a facility and receive pre-packaged retail platforms.

### BACKGROUND

As businesses seek to grow and expand, they encounter the predictable costs of acquiring new customers as well as the increasing costs of meeting the needs of the existing customer base. The cost of maintaining a sales force, marketing functions, ongoing promotions and more importantly the supply chain costs of delivering the product to the end consumer are significant. These operational costs generally affect all businesses, regardless of industry. This burden of operational costs incurred by businesses is passed on to consumers as part of retail pricing, and often impacts the competitive “supply and demand” nature and thus, affordability, of products.

Technological advances have allowed organizations to conduct business via electronic communication mediums, such as the ubiquitous Internet. Such business may take the form of online bidding/auction systems, virtual stores, etc. By way of this use of technology, costs associated with business have been greatly reduced. However, these cost savings derived by businesses do not always easily translate to cost savings for all types of buyers—large groups, smaller groups or individuals.

Currently, techniques for enhancing the manner in which businesses translate their cost savings into discounts/benefits for their buyers are gaining in popularity. For example, the discount quantity pricing approach to costing involves pricing a product at different levels or tiers depending upon the quantity of products a customer is willing to purchase (bulk purchasing). The larger the quantity of products a customer is willing to purchase, the lower the price. Sellers have incentive to lower price for large quantity buyers since the fixed costs associated with producing and delivering the product is spread over larger quantities. Thus, sellers are able to make profits despite the lowered price of the product.

While volume pricing offers a benefit to larger buyers who are able to purchase large quantities of goods at one time, smaller buyers and individual consumers are often unable to obtain discounted bulk pricing and therefore have to hunt around for the best available deal. This, however, hurts both the end-consumer and the original seller. For example, in one scenario, the smaller or individual buyer is often burdened by a higher aggregate price, since he has to buy either from a re-seller (retailer) or from the original seller while paying a non-discounted or near full price with the potential for higher delivery costs. The smaller or individual buyer may end up purchasing less due to budgetary constraints. As a result, the sellers are faced with potentially lost business since they are unable to reduce their price for the smaller buyers while still making a sufficient profit.

Another, now common, method of selling products is through online auctions. Although bidding provides advantages when selling unique products (for which customers are willing to competitively bid), the auction forum is not well-suited for sellers who desire to sell large quantities of goods to multiple buyers given the inefficiencies involved with selling one product at a time in an auctioning environment. In using the online auction method, however, the inefficiencies, which include delivery cost, individual order processing costs and lack of forecast or supply-planning remain unaddressed.

Furthermore, on a separate but related note, community groups and organizations such as schools, churches, charitable foundations, NGOs (Non-Government Organizations), etc. work to improve the quality of life through partnership with financial donors. However, soliciting monetary donations/funds from individuals by such organizations in support of such social/“good cause” endeavors is a costly and time-consuming effort. Attempts at soliciting monetary donations from individuals focused on telephone solicitation, direct mail, media-based and manual fundraising (i.e. door-to-door) are losing popularity and effectiveness. Limited results have so far been achieved in certain events where products with donations built into the price are offered for purchase, because they often lack competitiveness or attractive pricing that is otherwise available to consumers in the open market.

Therefore, what is needed is are methods and systems that provide an alternative to current supply chain options that foster an efficient and cost effective way of bringing products and services direct from original Sellers to end-consumers, translating into cost savings that can benefit end consumers and, optionally, the Community Groups (Organizations) to which they belong.

What is also needed is an opportunity or forum wherein a for-profit transaction, of sellers selling products to groups of consumers for profit, could actually optimize cost savings for consumers and drive charitable support to Organizations to which consumers belong.

### SUMMARY

The present application discloses a computer implemented method for enabling an e-commerce system, represented virtually by an administrator, for the sale of goods and/or services between a plurality of sellers and individual customers, who identify themselves to be affiliates of at least one of a plurality of Organizations, the method comprising the steps of: online registration of the plurality of Organizations who intend to facilitate cost savings for their members and also benefit from fundraising opportunities through the e-commerce system; online registration, and affiliation (to at least one Organization) of the customers who intend to use the e-commerce system for purchasing goods and/or services collectively, to realize cost savings and also help raise charitable funds for the Organization that they are affiliated to; online referral of new (not yet registered) Organizations by customers to the administrator; online formation of a virtual Organization, initiated by a customer, when an Organization of choice does not exist on the e-commerce system; followed by invitation by the customer to other customers to become members of the newly formed virtual Organization to attain minimum membership for the virtual Organization; nomination, selection or identification of Org Head for each Organization; identification and selection of an appropriate ad hoc distribution facility, based upon availability of ad hoc distribution facilities operated by third-parties, for each Organization (in one embodiment, the third party facilities are owned and rented by the Administrator of the e-commerce system of the present invention); online registration of the plurality of sellers, who intend to sell goods and/or services to registered members (customers), with the approval of their respective Organizations and with a pre-determined charitable benefit to the Organizations; online electronic publishing of a catalog comprising an offer to sell goods and/or services by a seller, the said catalog being characterized by at least a catalog period, method of delivering the goods and/or services, and a pledge to donate a pre-determined proportion of sales proceeds to concerned Organizations; online selection, by the registered sellers, of registered Organizations to be participants and beneficiaries of the said catalog; referral of the said catalog to the selected Organizations, by an Administrator of the e-commerce system, and follow-up for electronic acceptance of the said catalog by the selected Organizations; electronic acceptance (or non-acceptance) of the said catalog by the selected Organizations and electronic referral of the said catalog along with the said catalog characteristics to the plurality of customers affiliated with the selected Organizations; online purchase, by the said plurality of customers, of goods and/or services offered in the said catalog by the seller; compilation and processing, by the e-commerce system, of online purchases and electronic communication of resultant order data, delivery and distribution instructions to the seller; and electronic calculation and release of funds, automatically, to the seller and the Organizations based on a predetermined apportioning method.

In one embodiment, the customer who creates the virtual Organization and therefore, the founding member can identify himself/herself as the permanent Org Head, at the stage of Organization creation. In this case further nomination or acceptance of the Org Head is not required. Also, the founding member remains the Org Head of that Organization for the duration of the existence of the Organization on the e-commerce system of the present invention.

In accordance with an embodiment, Organizations can also initiate requests for specific catalogs for products needed by them by initiating a Catalog Request and specifying a catalog title and a list of up to ‘X’ desired items to go in that catalog. Other Orgs who share similar interests may view that Catalog Request and vote for their desired items already on the catalog and/or add more desired items (until the list reaches the number ‘X’). Each vote by an Org for an item carries a “point” equivalent to the number of registered members of that Org. Catalog Requests are assigned a Unique ID and have desired delivery window (or dates) set by the initiating Org. All registered Sellers can view Catalog Requests on the e-commerce online website. Accordingly, Sellers may choose to create new “customized catalog(s)” to meet the criteria of a specific Catalog Request. Sellers may use the Unique ID of the Catalog Request to automatically add all organizations that voted for items in that Catalog Request. The Administrator receives an alert and notation, in the form of draft catalog(s), when new “customized catalog(s)” is/are created against a Catalog Request. The Catalog Request goes off line either when the Administrator approves the draft catalog that is created against that Catalog Request or at the end of desired delivery window, whichever is earlier.

Optionally, the catalog is a Campus Catalog, Direct Catalog, or Soft Catalog. The electronic mail notifications are automatically sent to the customers affiliated to Organizations when their respective Organizations accept a catalog. In addition to electronic mail notifications, printed paper notifications are made available for distribution to the customers affiliated to the Organizations. Consumers can view online, the details and content of the said catalog at any time after acceptance of the said catalog by their respective Organizations, but can make actual purchases only during the Catalog Period. The funds received from the customers, as a result of purchase transactions, are held in escrow until deliveries of goods and/or services are performed by the sellers. The e-commerce system allows registration of voluntary or compensated Field Representatives and assigns them to specific Organizations. The Field Representatives can add or update a Market Profile to the registered Organizations assigned to them. According to the purchases the customers are alerted with automatic electronic mail notifications of shipment data.

In one embodiment the e-commerce system of the present invention also allows Sellers (with Administrator's approval) to post “Open Catalogs” that appear online during their review/acceptance period. Certain Open Catalogs follow a cyclic pattern such that an Open Catalog re-appears online as a “new edition” each time the review/acceptance period of previous edition is over. Each cycle of the Open Catalog is automatically assigned a different Catalog ID for unique identification within the e-commerce system of the present invention. Orgs may visit the “Open Catalogs” area to browse, select and add/accept those catalogs.

In accordance with an aspect of the present invention, the Org Head is prompted to confirm an ad hoc facility for a Catalog at the time of accepting the Catalog. The Org Head then chooses an ad hoc facility from either the options selected during Org formation or from new options presented. If the Org Head selects third party rental premises or portable storage, then he/she is alerted for rental finalization at the end of the Catalog period. Based on at least a combination of rental cost and availability, the Org Head selects and reserves the facility of choice on the system. Thereafter, the Org Head is presented with of a plurality of value added services to choose from and pay separately—at the chosen facility. On the other hand, if the Org Head does not select a third party rental premise or portable storage then he/she is prompted to select and confirm a facility (from a single or multiple facilities) owned or rented on a permanent basis by the Org.

Optionally, an Org Head is designated to receive deliveries of products/services on behalf of customers/members, affiliated to the Organization, who make the purchases, thereby the Org Head and customers releasing the e-commerce system of any liabilities. The customers can electronically affiliate themselves to more than one Organization, or delete (end affiliation with) current Organizations. The catalog is subject to review, revision and approval by the Administrator, before it is assigned to Organizations. The seller is provided access to database of registered Organizations through the Basic and Market Profile data filters, to enable the seller to review database results obtained based on said filters and thereby select the Organizations that are most suitable for their catalogs. The funds released to the seller comprise of guaranteed manufacturers cost (GMC) and also whole or portion of escrowed shipping funds (ESF) reserved for mitigating the seller's risk of higher delivery costs resulting from insufficient purchase volumes by the customers in case of Campus Catalogs. The funds released to the Organizations may comprise predetermined charitable funds or donations (GFO). The funds released to the Field Representatives comprise a predetermined Field Representative Commission (RCF).

In another embodiment, the present specification discloses a method, implemented in an e-commerce system, of mitigating a seller's risk of higher delivery costs resulting from insufficient volumes of products and/or services ordered by customers affiliated to an Organization; the method comprising the steps of: establishing a desired average volume per Organization for delivery of goods and/or services; establishing a price of goods and/or services including delivery cost; establishing a catalog period; establishing reserve funds as a percentage of total actual sales to be held in escrow to compensate the seller for higher delivery costs resulting from insufficient volumes of products and/or services ordered during the catalog period; and distributing the reserve funds to the seller and/or the Organization based on an apportioning method.

Optionally, a predetermined portion of said price of goods and/or services is guaranteed to be paid to the seller as Guaranteed Manufacturer's Cost (GMC). The desired average volume per Organization is predetermined and termed as Guaranteed Average Volume (GAV). The reserve funds as a percentage of total actual sales to be held in escrow is predetermined and termed as Escrowed Shipping Funds (ESF). A Shipping Allowance Factor (SAF) is pre-determined for the purpose of implementing the apportioning method and for specifying how the ESF would be allocated based on whether or not GAV is achieved in actual transactions. If purchases of goods and/or services are made, then based on an Actual Shipping Value (ASV), the apportioning method comprises the steps of: determining if the Actual Shipping Value (ASV) meets, exceeds or falls short of a Guaranteed Average Volume (GAV); and b) determining if ASV meets or exceeds GAV, then allocating the reserve funds equivalent to ASV*ESF as donation (in addition to GFO) to the Organization, wherein the ESF is predetermined Escrowed Shipping Funds; if ASV<GAV, but, >(GAV−(GAV*SAF %)) then releasing the reserve funds equivalent to {(GAV−ASV)/(GAV*SAF %)}*(ASV*ESF %) to the seller and funds equivalent to (ASV*ESF %) [1−{(GAV−ASV)/(GAV*SAF %)}] as donations to the Organization; or if ASV≦(GAV−(GAV*SAF %)) then releasing the reserve funds equivalent to ASV*ESF % to the seller and no funds as donations to the Organization.

Optionally, certain funds, predetermined as Guaranteed Funds to Organizations (GFO), as donations are guaranteed to the Organization even if the ASV falls short of the GAV. A predetermined portion of said price of goods and/or services is retained as processing cost (PRC) by the e-commerce system. Any or all of the following exceptions are made with regards to final allocation or disbursement of funds accumulated in ESF: all funds allocated (out of ESF) to Seller or Organization(s) can be held further in escrow until Catalog becomes “Closed Catalog” and all returns and exchanges are resolved; funds allocated (out of ESF) to Organization(s) may be retained by Administrator as discretionary funds to meet marketing expenses related to promoting business with those Organization(s); and/or funds allocated (out of ESF) to Organization(s) may be re-routed and distributed to Customers (as rebates) or to Field Reps (as performance incentives). Customers can establish direct or indirect affiliation or membership with Organization(s); and wherein an indirect membership requires identifying Alias on the e-commerce system. Customers desirous of purchasing add out of stock items can add the said items to a Wish-List; thereby also causing the e-commerce system to periodically and automatically notifying relevant seller of the aggregated Wish-List. Once the seller adds a Wish-List item back to inventory, the said item becomes in-stock again and the concerned customers are automatically notified. Once the customer purchases the in-stock item, the said item is then removed from the customer's Wish-List. The Org Head tracks and confirms receipt of products/services, real-time, using mobile messaging applications. The release of funds can be tracked, real-time, by the sellers, Organizations and Field Representatives.

In another embodiment, an Organization can establish or define recommended product lists for its members/customers, as part of the catalog acceptance process so that the member/customer can view and add the recommended list(s) of products to their cart, in its entirety. Further, the customer can view and choose variants of standardized items that appear in recommended product list(s).

In another embodiment, the present specification discloses servers programmed to execute instructions that, when executed, perform one or more of the above described methods.

The aforementioned and other embodiments of the present shall be described in greater depth in the drawings and detailed description provided below.

### BRIEF DESCRIPTION OF THE DRAWINGS

These and other features and advantages of the present invention will be further appreciated, as they become better understood by reference to the detailed description when considered in connection with the accompanying drawings:

FIG. 1 shows an illustration of one embodiment of an online marketplace or e-commerce system of the present application;

FIG. 2a illustrates a campus catalog-related process enabled by the e-commerce system of the present application;

FIG. 2b illustrates a direct catalog-related process enabled by the e-commerce system of the present application;

FIG. 2c illustrates a soft catalog-related process enabled by the e-commerce system of the present application;

FIG. 3A is a flow diagram illustrating exemplary steps related to formation of an Organization;

FIG. 3B is a flow diagram illustrating exemplary steps related to the process of the Org Head confirming an ad hoc facility;

FIG. 4 illustrates exemplary functionalities and features in an Organization Console architecture;

FIG. 5 shows the life cycle of a catalog of products/services in accordance with an embodiment of the present application;

FIG. 6 is a flow diagram illustrating tasks related to registration and other navigation functionalities and features available to a Seller;

FIG. 7 is a flow diagram illustrating exemplary steps involved in creating a new catalog;

FIG. 8 is a flow diagram illustrating navigation functionalities available to a Customer;

FIG. 8B is an exemplary GUI illustrating a catalog view available to a Customer featuring Recommended Products Lists;

FIG. 9 is a flow diagram illustrating tasks related to registration and other navigation functionalities available to a Representative;

FIG. 10A is a flow diagram illustrating one embodiment of an apportioning method for calculating proportionate distribution of reserves to Sellers and Organizations;

FIG. 10B is a table showing several examples of the apportioning method described in FIG. 10A;

FIG. 11 is an illustration of an exemplary GUI, of the Organization Console of FIG. 4, showing an example “alert”;

FIG. 11B is an illustration of an exemplary GUI showing a catalog page embedded with the Recommended Products List capability, as viewed by an Organization;

FIG. 11C is an illustration of an exemplary GUI showing a typical list creation template used by an Organization in the Recommended Products List process;

FIG. 12 shows an exemplary GUI where Sellers can view catalogs along with the list of Organizations to which the catalogs have been assigned to;

FIG. 13 shows an exemplary GUI where Sellers can search and assign Organizations;

FIG. 14a shows an exemplary GUI where Sellers can search Organizations based on basic, demographic and market profiles;

FIG. 14b shows an exemplary GUI where Sellers can search Organizations based on basic, demographic and market profiles;

FIG. 15 shows an exemplary GUI for use by a Consumer (members/customers) to affiliate themselves to new Organizations;

FIG. 16 shows an exemplary GUI for Consumers to view a listing of posted catalogs, their status, and related information;

FIG. 17 illustrates an exemplary campus catalog related report regarding a bulk packing list by the Organization, as proof of delivery of products/services;

FIG. 18 illustrates an exemplary campus catalog related report in a customer-based order summary log and associated receipts;

FIG. 19 illustrates an exemplary campus catalog related report regarding shipment notification for upload;

FIG. 20 illustrates an exemplary direct catalog related report for a customer-based order summary;

FIG. 21 illustrates an exemplary direct catalog related report regarding shipment notification for upload;

FIG. 22 illustrates an exemplary soft catalog related report for a customer-based order summary;

FIG. 23 illustrates an exemplary report (usable for all types of catalogs) for an end of catalog cost distribution summary;

FIG. 24 illustrates an exemplary report (usable for all types of catalogs) for an end of catalog sales and cost distribution summary for a specific Organization;

FIG. 25 illustrates an exemplary catalog sales tracking report created for an Administrator and/or Seller;

FIG. 26 illustrates an exemplary catalog sales tracking report created for an Organization;

FIG. 27 illustrates an exemplary end of catalog report created for an Administrator and/or Seller; and

FIG. 28 illustrates an exemplary end of catalog report created for an Organization.

### DETAILED DESCRIPTION OF THE INVENTION

The present application is directed towards an e-commerce business/system (“System”) that facilitates sale of goods and/or services between a seller and individual consumers identifying themselves to be affiliates/members of a community group (“Organization”), with a primary purpose of saving money for consumers. In one optional embodiment, the System also coordinates raising charitable funds for the Organization through such sale.

In addition, the present application is directed towards a System that facilitates identification, aggregation and registration of such Organizations, to help its constituent consumers/members realize cost savings through collective buying opportunities and to optionally pledge savings realized through such buying as charitable funds to be donated to the Organization.

In addition, the present application is directed towards a System that provides to interested sellers, a retail platform for specified periods of time, to reach and sell to specific group(s) of consumers who constitute Organizations defined by demographics, such as but not limited to socio-economic factors, geographical location and known buying preferences.

The present application is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present application is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The following terms are defined below to facilitate understanding of the methods/processes related to the e-commerce system of the present invention. It should be noted, however, that these definitions are not to be construed as limiting, but rather to increase the understanding of the invention. The term “Administrator” is used to represent a functional entity/representative that represents the e-commerce business/establishment that is facilitating/enabling the marketplace of the present invention. The term “Organization” (also referred to as “Org”) is used for an establishment or community group that registers with the e-commerce business to facilitate online purchases from its members. The terms “Customer”, “Buyer” and “User” are used interchangeably to represent a member or associate of an Organization that registers with the e-commerce business and establishes affiliation to the Organization. “Seller” is used to denote a seller of products or services (also referred to as a “catalog”) registered with the e-commerce business. A “Field Representative” (“Rep”) is a representative who works as a physical human interface between the e-commerce business and Organizations to facilitate business process through follow-up.

A “Catalog” is a product or service or group of products or services, posted by a registered seller that stays active on-line for a pre-determined period of time and is visible only to customers belonging to organizations to which the catalog is assigned. There are three types of catalogs—campus catalogs, direct catalogs, and soft catalogs. A “Campus Catalog” is one in which a seller ships products to an Organization for further distribution to affiliated customers who pre-ordered the products. For Campus Catalogs, the Organizations are required to login to the e-commerce system and acknowledge merchandize delivery. A “Direct Catalog” is one in which the seller ships the product directly to a customer. A “Soft Catalog” is one in which the seller delivers the product(s) or service(s) directly to customers using an online data transfer method.

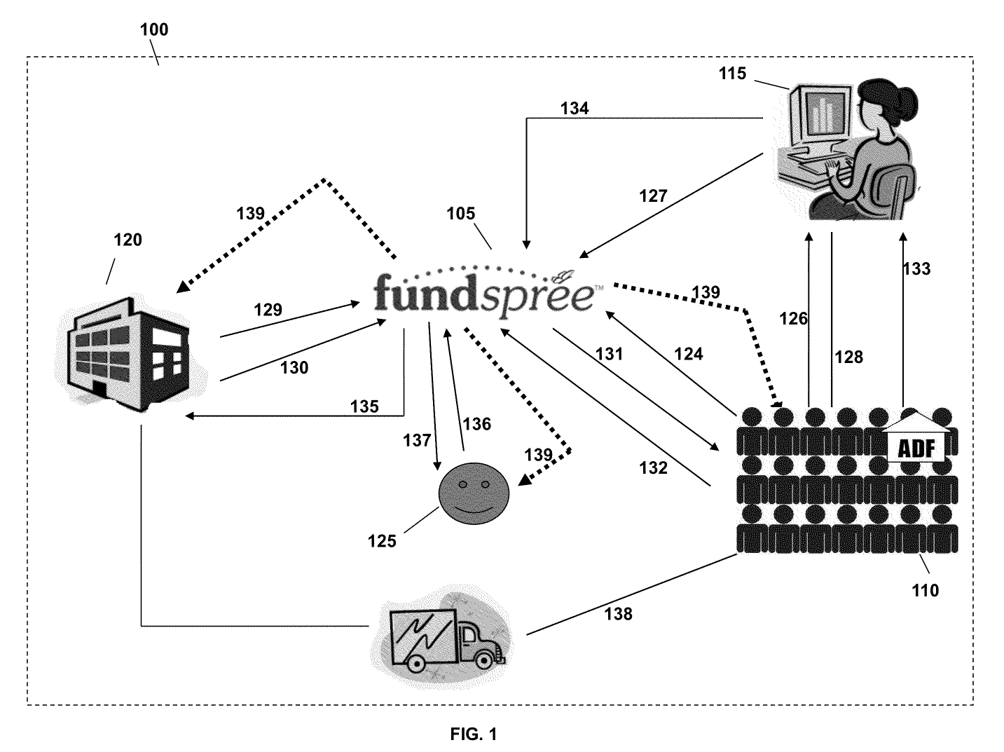

FIG. 1 shows an embodiment of the online marketplace or e-commerce system 100 of the present invention illustrating related entities/parties and high-level processes. Referring now to FIG. 1, the entities/parties comprising system 100 are: an Administrator 105; at least one Organization 110; at least one customer/buyer/member 115; and at least one Seller 120 of a catalog of product(s) and/or services.

In one embodiment, the Organization 110 never purchases anything itself, but rather acts as a facilitator or moderator of the business process. Also, in one embodiment, the system 100 comprises a plurality of Field Representatives 125 that function as human, physical interface(s) between the e-commerce business, represented by the Administrator 105, and Organizations 110 to facilitate business process through follow-up. The Field Representatives 125 are independent volunteers or compensated agents who register with the e-commerce business and are assigned (by the Administrator) at least one registered Organization for the purpose of assisting and promoting the e-commerce business process.

The e-commerce system 100 of the present application, in one embodiment, is implemented as software program/application along with a front-end online website (as Graphical User Interface or GUI) that reside on one or more server computers (or on a distributed server system for scalability and high availability) in communication with a network. The entities/parties related to the system 100 are configured as client computers that are also in communication with the network. The e-commerce business or establishment, represented by the Administrator 105, is the legal owner of the e-commerce system and therefore becomes the enabler/facilitator of the system 100. Persons of ordinary skill in the art would appreciate that the network could be public or private LAN, WAN, MAN. In one embodiment, the network is the public Internet.

The functionality of the e-commerce system 100 of the present application is illustrated through the following high level process steps. First, in one embodiment, communication channels are established in order to use the e-commerce system of the present invention. An Organization 110 registers 124 with the e-commerce system of the present invention and invites 126 customers for affiliation. A Customer 115 registers 127 with the e-commerce system and establishes 128 their affiliation to one or more Organizations that are already registered using the e-commerce system. A Seller 120 also registers 129 with the e-commerce system.

A Seller 120 then uploads 130 at least one catalog of products/services and selects Organizations with which seller would like affiliate and sell his catalog(s) of products/services. This information is submitted to the Administrator. The Administrator reviews, revises (if required), approves and assigns 131 the catalog(s) to the selected Organizations. The Organizations (through a designated Organization Head) also, thereafter, reviews and accepts 132 the catalogs posted to them. Thereafter, the System 100 enables Organizations to alert 133 the members (customers) (preferably automatically, such as, through email, mobile messaging, and/or web-link alerts), that are affiliated to it, of the allocated catalogs available for purchase.

While the allocated catalogs are available for purchase online, customers 115 can login to the e-commerce system and shop/purchase 134. The e-commerce system 100 then processes 135 customer purchase orders and sent to the respective Sellers, in accordance with the catalogs type. In one embodiment, there are three types of catalogs: Campus, Direct and Soft, as described above.

In another embodiment, and described in greater detail below, an Organization can establish or define recommended product lists for its members/customers, as part of the catalog acceptance process so that the member/customer can view and add the recommended list(s) of products to their cart, in its entirety. Further, the customer can view and choose variants of standardized items that appear in recommended product list(s).

In another embodiment, instead of Sellers initiating the catalog process at step 130, the e-commerce system alternatively and/or additionally allows/enables Orgs to initiate requests for specific catalogs for products they need. A “Catalog Request” area is provided on the e-commerce online website that is accessible to all registered Orgs. An Org can initiate a Catalog Request by activating/clicking on “initiate request” and completing information such as a catalog title/name and a list of up to ‘X’ items, or desired items to go in that catalog. In one embodiment, ‘X’ is an arbitrary number, for example, but not limited to 20. Other Orgs who share similar interests may view that Catalog Request and vote for their desired items already on the catalog and/or add more desired items (until the list reaches the number ‘X’) until an appropriate catalog is established. In one embodiment, each vote by an Org for an item carries “points” that are equivalent to the number of registered members of that Org. Thus, the popularity of each item on a Catalog Request is measured and updated by the points it gathers through voting. Catalog Requests are assigned a Unique ID and have a desired delivery window (or dates of delivery) set by the initiating Org.

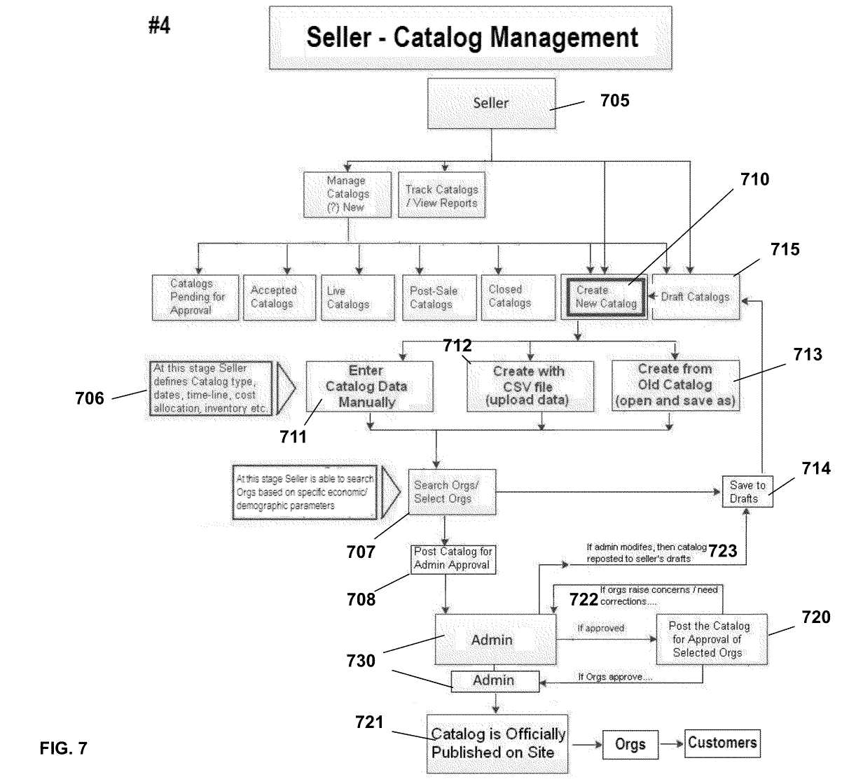

All registered Sellers can view Catalog Requests on the e-commerce online website. Accordingly, Sellers may choose to create new “customized catalog(s)” to meet the criteria of a specific Catalog Request. Sellers may use the Unique ID of the Catalog Request (such as during Org search and assign step 707 described later with respect to FIG. 7), to automatically add all organizations that voted for items in that Catalog Request. The Administrator receives an alert and notation, in the form of draft catalog(s), when new “customized catalog(s)” is/are created against a Catalog Request. Thereafter, the Catalog Request goes off-line either when the Administrator approves the draft catalog that is created against that Catalog Request or at the end of desired delivery window, whichever is earlier.

Referring back to FIG. 1, in one embodiment, at least one Field Representative 125 also registers 136 with the e-commerce system, as a result of which the Administrator receives an alert that a Representative 125 has registered. The Administrator then assigns/adds 137 at least one Organization 110 to the Representative 125. As a result, the Representative 125 gets necessary alerts (described later under section “Field Representatives' Navigation”) related to the Organizations in his portfolio. In one embodiment, Field Representatives first register, then prospect, solicit and facilitate the registration of new organizations in their territories, after which the Administrator establishes assignment of such Organizations to respective Field Representatives.

The Seller 120 delivers 138 products/services to the Organization, for further distribution (by the Organization) to the members/customers (assuming, in this embodiment, that the catalog posted by the Seller is a Campus Catalog). The Organization (through a designated Org Head) can track ordered products/services in real-time through mobile messaging and tracking applications, known to persons of ordinary skill in the art. On successful receipt of products/services, the concerned Organization can send a virtual “delivery acknowledgement” (such as through email, mobile messaging, online or any other electronic form evident to persons of ordinary skill in the art) to the Seller of the products/services.

In one embodiment, the e-commerce system of the present application allows the Sellers an option to back-order part of the aggregated sale and/or prioritize partial shipments/deliveries based on criteria such as, for example, a “first-come, first-served” policy.

In one embodiment, Seller may use online tools or mobile applications provided by the e-commerce system to electronically upload shipment tracking data for the benefit of members/customers, so they may be instantly updated on their order/delivery status.

Finally, the e-commerce system (represented by the Administrator 105) releases 139 “appropriate funds” to the Sellers, Organizations and the Representatives. Persons of ordinary skill in the art should appreciate that the release of funds can be tracked by the Sellers, Organizations and Representatives, in real-time, using mobile messaging and tracking applications integrated with the e-commerce system 100.

In one embodiment, with reference to Sellers, the “appropriate funds” refer to the escrow funds (described below) available for mitigating the Seller's risk of increased delivery cost due to insufficient purchase volumes. With reference to Organizations, the “appropriate funds” refer to cost savings to members/customers (that accrues to them as a result of achieving certain purchase volume through group buying) that are optionally donated as charitable funds (partially or fully), to Organizations. Persons of ordinary skill in the art should appreciate that the “appropriate funds” do not represent value of goods purchased as these are paid by buyers to sellers directly (preferably online using third party payment gateways). Thus, upon purchase, the e-commerce system of the present invention is immediately released of all liabilities related to payment and delivery of products/services. Also, with reference to Representatives, the “appropriate funds” refer to the Field Representative Commission (“RCF”) which is a pre-defined percentage (%) of selling price of all products on catalog, that is payable to the Field Representative and is not related to escrow funds.

According to one embodiment of the present application, the e-commerce system implements novel methods/processes for mitigating a Seller's risk of increased delivery costs due to insufficient purchasing volumes; enabling customers/members to take advantage of cost savings through group buying via Organizations; and optionally allowing customers/members to donate the savings realized as charitable funds to their Organizations.

The following terms are defined below to facilitate understanding of the methods/processes implemented by the e-commerce system of the present invention. It should be noted, however, that these definitions are not to be construed as limiting, but rather to increase the understanding of the invention.

“Guaranteed Manufacturer's Cost” (GMC) is used to refer to a pre-defined and fixed percentage (%) of the selling price of all products on catalog, that is payable to Seller, and includes the shipping cost from the Seller to Organization(s).

“Guaranteed Funds to Organization” (GFO) represents a pre-defined percentage (%) of the selling price of all products on the catalog, that is payable to the Organization as a donation.

The “Processing Cost” (PRC) is the processing cost charged by the e-commerce business/system and is calculated as a pre-defined percentage (%) of the selling price of all products on a catalog, payable to the e-commerce business/system.

The Field Representative Commission (RCF) is a pre-defined percentage (%) of the selling price of all products on a catalog that is payable to a Field Representative in the form of commissions.

“Escrowed Shipping Funds” (ESF) refers to a percentage of actual sales (ASV) to be held in escrow with the administrator for mitigating the potential delivery cost risk to the Seller.

The following factors, which are not components of cost, are applicable to the Campus Catalog only.

The “Guaranteed Average Volume” (GAV) refers to a dollar value that indicates the minimum desired value of average sales to be achieved by Organizations during a Catalog period, for a seller to maintain the GMC.

The “Actual Shipping Value” (ASV) is a dollar value of actual purchases (deliveries), by an organization OR an average of actual purchases by several organizations.

The “Shipping Allowance Factor” (SAF) refers to a percentage (%) gap or short-fall in actual purchases (ASV) when compared to GAV that entitles the Seller's claim to the entire balance of ESF funds. It should be noted herein that SAF is a factor that is used for calculation of ESF allocation, and is not a component of price. For example, if GAV is $1000 and SAF is 40%, Seller would claim entire ESF funds (ASV*ESF %) if ASV is equal or below $600 {(GAV)−(GAV*SAF %)}. If ASV is between $601 and $999, it would mean that the Organization did not achieve GAV, but they crossed the short-fall threshold (40%) established by SAF; in this scenario ESF funds are divided and allocated proportionately between Seller and Organization.

It should be understood by persons of ordinary skill in the art that the delivery cost of products/services varies based on purchase volume and may become unexpectedly higher in cases where Organizations (as groups of consumers) do not meet the volumes desired by the Seller. The following high-level process steps of the e-commerce system of the present invention helps mitigate such a risk of the Sellers while appropriately providing additional cost benefits to customers/members of Organizations (if desired purchase volumes are reached). In one embodiment of the present invention, the additional cost benefit is optionally passed on as donations to the Organization(s). In a first step, a “desired volume” (that is, GAV) is established for each delivery. In a second step, a flat price that includes a standard delivery cost (and any other incidental costs) based on the “desired volume” (GAV) and a “reserve” component (escrow funds/ESF) to be held in escrow for the purposes of compensating higher delivery costs (resulting from insufficient purchase volume) is established. In a third step, a specific apportioning method is applied for calculating and establishing a proportionate distribution of such “reserves” (ESF) to the Seller and Organization(s), based on the actual sales volume (ASV). In one embodiment, such “reserves” (ESF) are held in escrow until deliveries of goods and/or services are performed by the Seller.

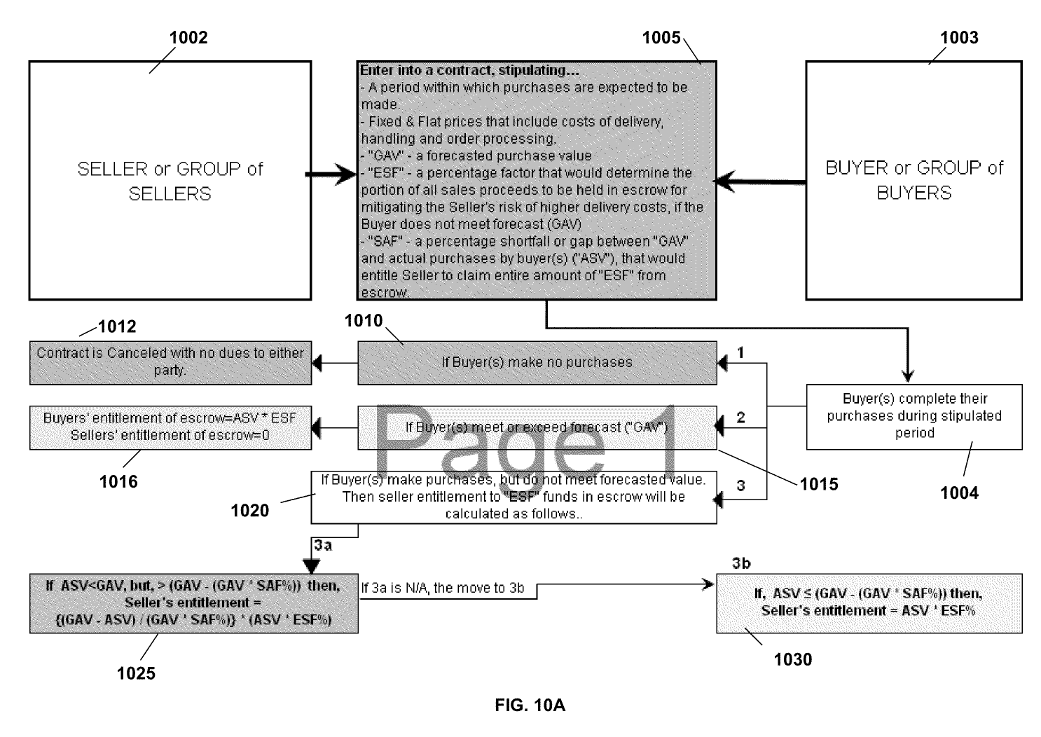

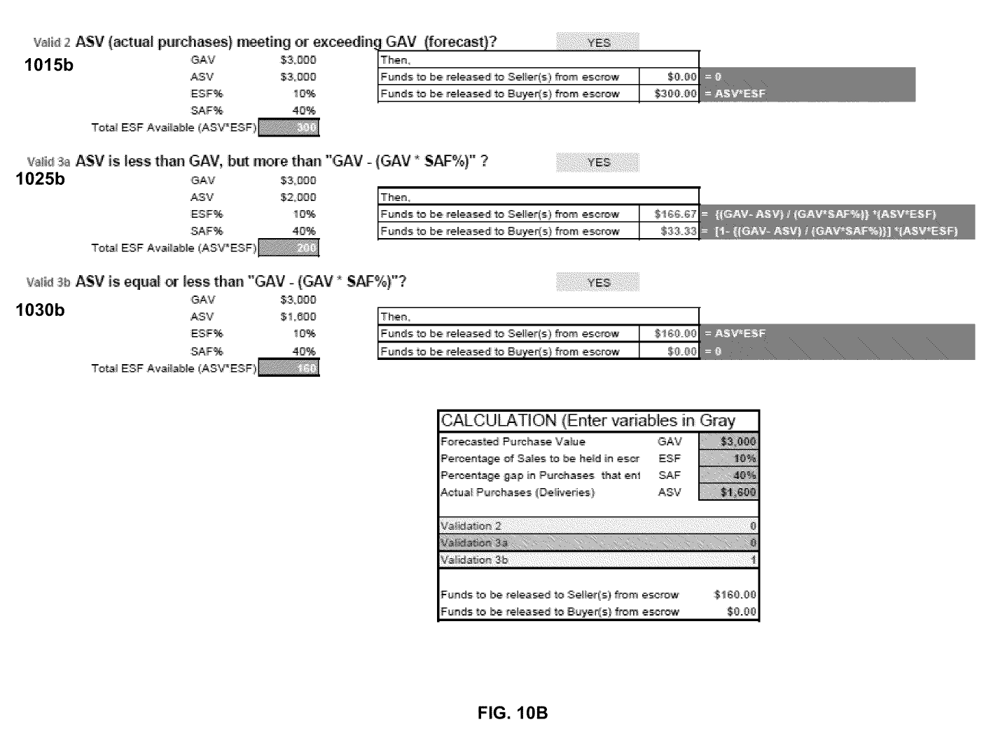

FIG. 10A is a flow diagram illustrating one embodiment of the apportioning method for calculating proportionate distribution of escrow reserves to Sellers and Organizations. FIG. 10B is a table showing several examples of the apportioning method described in FIG. 10A. Reference will be made to both FIGS. 10A and 10B simultaneously, where appropriate. Referring now to FIG. 10A, when a catalog of a Seller 1002 is accepted by an Organization (buyer or group of buyers) 1003, the Organization (on behalf of its members/customers/buyers) is deemed to have entered into a Contract 1005 stipulating at least the following aspects, in one embodiment: a) the Catalog Period, which represents the dates and duration through which a catalog is open online for purchases and b) fixed and flat prices that include the cost of shipping and handling. In one embodiment, pricing components are determined based upon the type of catalog, as shown in Table 1.

TABLE 1

| | Campus Catalog | Direct Catalog | Soft Catalog |
|---|---|---|---|
| GMC | Mandatory Component | Mandatory Component | Mandatory |
| | | | Component |
| GFO | Optional Component | Optional Component | Optional |
| | | | Component |
| PRC | Mandatory Component | Mandatory Component | Mandatory |
| | | | Component |
| ESF | Mandatory Component | Not Applicable | Not Applicable |
| RCF | Optional Component | Optional Component | Optional |
| | | | Component |

In addition, it should be noted that the GAV (a dollar value) and SAF (%) are established as factors in case of Campus Catalog only, because this type of catalog requires bulk-delivery of uncertain volume of purchases and exposure to risk of higher delivery cost. These factors are not applicable to Direct and Soft Catalogs, since these types of catalogs have fixed and predictable delivery costs due to direct delivery to purchasers.

It should be understood that the customers/members of the Organization need to complete purchases within the stipulated catalog period, as shown in step 1004. If at step 1010, the customers/members of the Organization do not make any purchases within the catalog period, the contract is cancelled 1012 with nothing due to any party (Seller or Buyer).

At step 1015, if the customers/buyers (that are members of the Organization) make enough purchases such that the purchases (ASV) meet or exceed the GAV, then at step 1016 the Buyer's entitlement of escrow funds (which, optionally translates to donations to the Organization, along with GFO) is calculated as ASV*ESF while the Seller is not entitled to any escrow funds. That is, in one embodiment, the entire ESF is paid out to the Organization. In other words, the customers/buyers get the group cost saving of ASV*ESF which they automatically pass on as additional donations to their Organization along with GFO.

An exemplary calculation 1015b is shown in FIG. 10B. As shown in FIG. 10B, if GAV is $3,000 and ASV is $3,000, thus ASV meets (or exceeds) GAV, and ESF is 10% while SAF is 40%, then the Buyer's entitlement of escrow funds is calculated as ASV*ESF, or 10% of $3,000. Therefore, the total ESF available is $300, but is paid to the Buyer(s) from escrow.

However, if customers/buyers do make purchases but do not meet the forecasted value (GAV), as shown in step 1020, then the Seller and Organization (via cost savings realized by its customers/members) are entitled to escrow funds calculated, in one embodiment, in accordance with the following conditions:

a) Condition 1 (shown as Step 1025):

If ASV<GAV, but, >(GAV−(GAV*SAF %)) then, Seller's entitlement of ESF={(GAV−ASV)/(GAV*SAF %)}*(ASV*ESF %) while the Organization's entitlement of ESF=(ASV*ESF %)*[1−{(GAV−ASV)/(GAV*SAF %)}]

As shown in FIG. 10B, exemplary calculation 1025b is as follows: If GAV is set at $3,000 and ASV is $2,000 (which is less than GAV), while ESF is 10% and SAF is 40%, then the ESF is calculated as $200 (ASV*ESF). This amount is apportioned between Seller and Buyer so that Seller can offset costs associated with the shortfall. Seller's entitlement of ESF is calculated as {(3,000−2,000)/(3,000*0.40)}*(2,000*0.10)=166.67 and Buyer's entitlement of ESF is calculated as (2,000*0.10)*[1−{(3,000−2,000)/(3,000*0.40)}]=33.33.

b) Condition 2 (shown as Step 1030): (will be applied if Condition 1 is not met)

If ASV<(GAV−(GAV*SAF %)) then, Seller's entitlement=ASV*ESF % and the Organization's donation (cost savings of its customers/members)=0. As shown in FIG. 10B, as 1030b, if ASV is $1,600 and GAV is $3,000, then ASV is less than GAV with the shipping allowance factored in, and the ESF available is calculated as $1,600*0.10=$160.00, and the funds go to Seller.

In one embodiment, where a contract is established for selling to multiple organizations simultaneously through one Catalog, the ASV for above calculations could be derived by taking the average of individual ASVs of all the organizations involved.

The funds entitlement to different parties (Seller, Organization) can be estimated and tracked in real-time as well as after end of catalog period, by the e-commerce system on the basis of the apportioning method. Similarly, funds are automatically dispersed to each interested party thereafter. In one embodiment, the apportioning method and automated funds disbursement process is programmed in the form of a software module that forms part of the e-commerce system/platform.

Persons of ordinary skill in the art should appreciate that the formulae and corresponding conditions can be customized in alternate embodiments without departing from the scope of the present invention. For example, in one embodiment, the escrow funds are meant to only cover the Seller's risk of unmet costs due to insufficient purchase volumes, while the Organization is guaranteed the specified GFO if purchases are made but may not be promised or allocated any portion of ESF. Alternatively, if the GFO is not specified in the catalog set-up, then the only source of funds for the Organization would be from ESF based on allocation as derived through the apportioning method.

In one embodiment, any or all of the following exceptions are made with regards to final allocation or disbursement of funds accumulated in ESF:
All funds allocated (out of ESF) to Seller or Organization(s) can be further held in escrow until Catalog becomes a “Closed Catalog” and all returns and exchanges are resolved;
Funds allocated (out of ESF) to Organization(s) may be retained by the Administrator as discretionary funds to meet marketing expenses related to promoting the business with those Organization(s);
Funds allocated (out of ESF) to Organization(s) may be re-routed and distributed to Customers (as rebates) or to Field Reps (as performance incentives).

Various processes enabled by the e-commerce system of the present invention with respect to the three types of catalogs will now be described.

### Campus Catalog

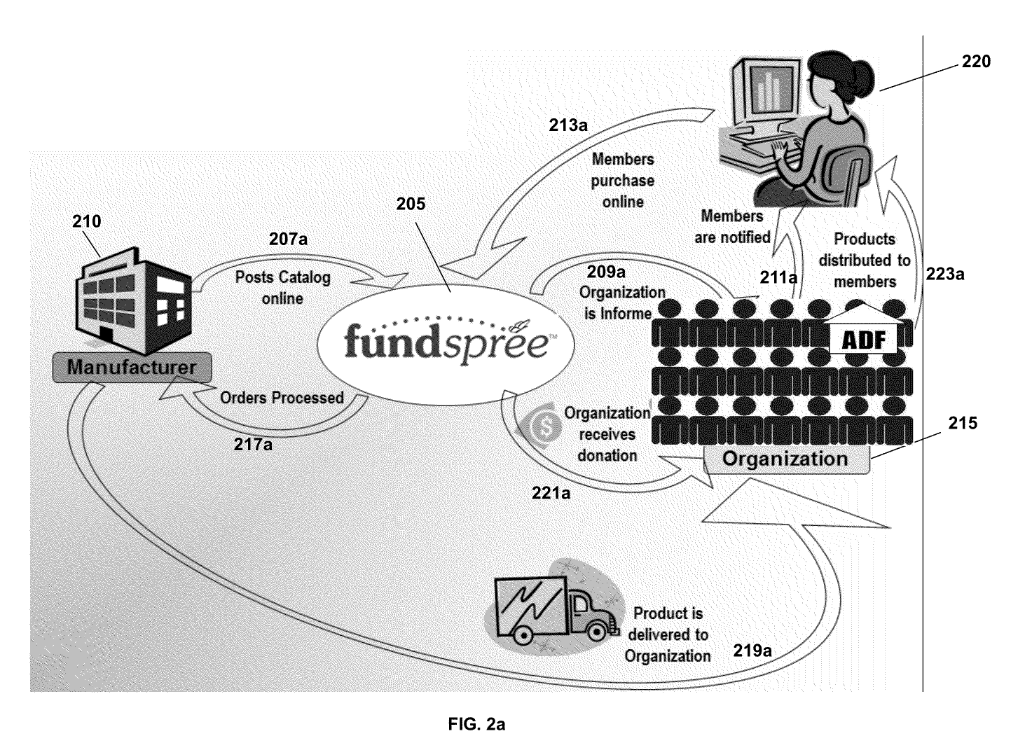

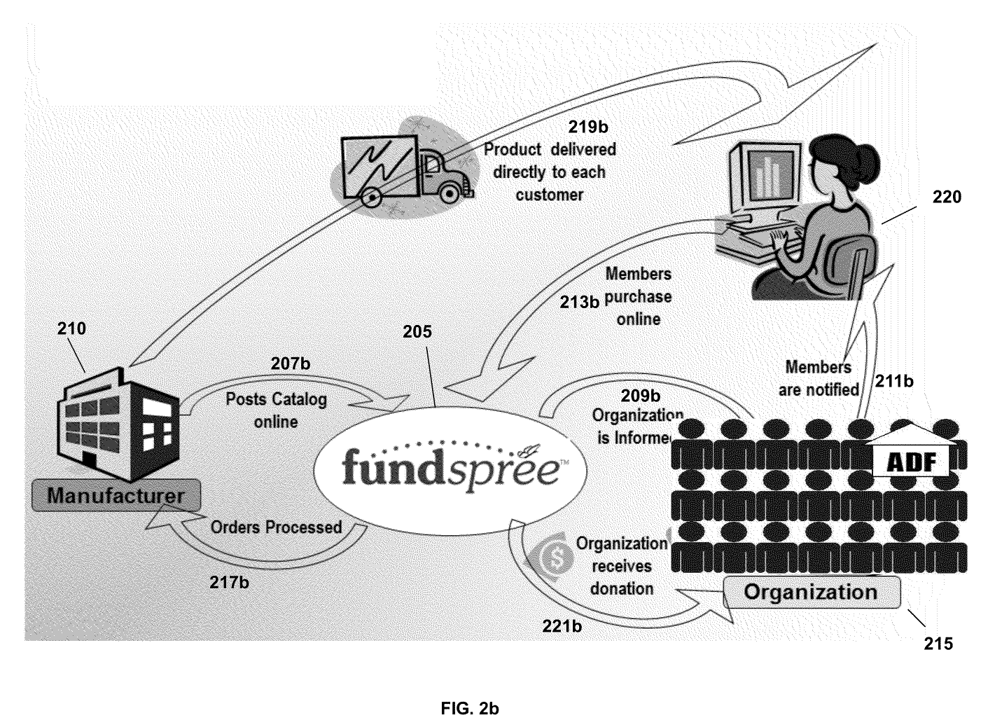

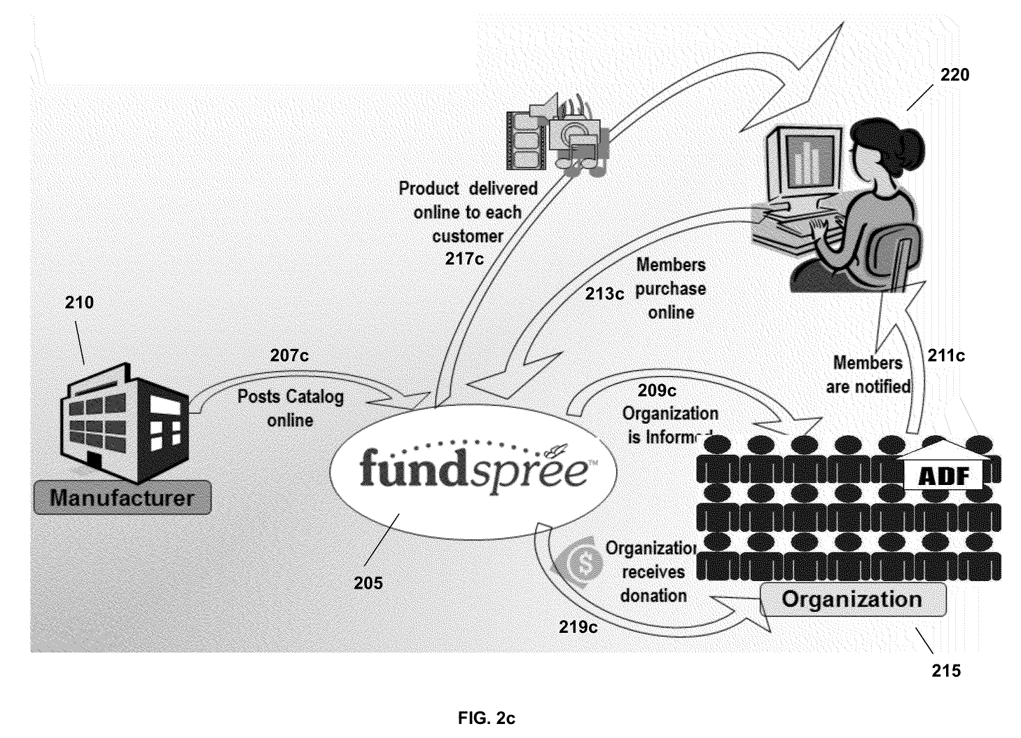

FIG. 2a illustrates an overview of the campus catalog-related processes enabled by the e-commerce system of the present invention. Referring to FIG. 2a, the e-commerce system 205 of the present invention allows registered sellers/manufacturers 210 to post catalogs of goods and services online, at step 207a. Then, at step 209a, Organizations 215 registered with the system 205 are electronically informed (by the Administrator representing the e-commerce system) of posted catalogs relevant to the Organizations preferences. Thereafter, at step 211a, the Organizations 215 notify or alert the members/customers 220 affiliated with them of the catalog of products/services available for purchase. At step 213a, the members 220 purchase products/services online from the relevant catalogs posted to the Organization 215 to whom the members are affiliated with. For a given catalog, aggregated purchase orders from all members of an Organization are sent to the seller 210 of the catalog for processing, at step 217a. On successful processing of the purchase orders, the seller 210 delivers the ordered products to the concerned Organization 215, at step 219a. The Organization 215 also receives GFO (if specified) along with appropriate escrow funds (as donations) from the system 205, at step 221a, in accordance with the apportioning method of FIG. 10A (similarly, the Seller 210 may also receive the specified GMC along with appropriate escrow funds in accordance with the apportioning method of FIG. 10A; and still similarly, the Field Representatives receive their RCF). The Organization 215 distributes the received products to affiliated members who purchased the products, at step 223a.

### Direct Catalog

FIG. 2b illustrates an overview of the direct catalog-related processes enabled by the e-commerce system of the present invention. Referring to FIG. 2b, the e-commerce system 205 of the present invention allows registered sellers/manufacturers 210 to post catalogs of goods and services online, at step 207b. Then, at step 209b relevant Organizations 215 registered with the system 205 are electronically informed (by Administrator representing the e-commerce system) of the relevant posted catalogs. Thereafter, at step 211b, the Organizations 215 notify or alert the members/customers 220 affiliated with then of the catalog of products/services available for purchase. At step 213b, the members 220 purchase products/services online from the relevant catalogs posted on the Organizations 215 with which the members are affiliated. For a given catalog, aggregated purchase orders from all members of an Organization are sent to the seller 210 of the catalog for processing, at step 217b. On successful processing of the purchase orders, the seller 210 delivers, at step 219b, the ordered products directly to the concerned members 220. The Organization 215 optionally receives their apportioned GFO, in step 221b, if specified in catalog set-up; similarly, the Seller 210 receives the specified GMC in accordance with the catalog set-up.

### Soft Catalog

FIG. 2c illustrates an overview of the soft catalog-related processes enabled by the e-commerce system of the present invention. Referring to FIG. 2c, the e-commerce system 205 of the present invention allows registered sellers/manufacturers 210 to post catalogs of goods and services online, at step 207c. Then, at step 209c relevant Organizations 215 registered with the system 205 are electronically informed (by Administrator representing the e-commerce system) of the relevant posted catalogs. Thereafter, at step 211c, the Organizations 215 notify or alert the members/customers 220 affiliated with then of the catalog of products/services available for purchase. At step 213c, the members 220 purchase products/services online from the relevant catalogs posted to the Organizations 215 with which the members are affiliated. On successful realization of purchase value, the System enables instant online delivery of ordered products from seller 210 to the concerned members 220, at step 217c. The Organization 215 optionally receives their apportioned GFO, in step 219b, if specified in catalog set-up; similarly, the Seller 210 receives the specified GMC in accordance with the catalog set-up.

In one embodiment, the e-commerce system of the present invention provides functionalities to the Sellers where the inventory of products on their catalog is automatically distributed amongst all Organizations that have accepted the catalog, proportionate to the number of members in the Organizations or the past purchase history of the Organizations or any other criteria that may be evident to persons of ordinary skill in the art. The e-commerce system, in one embodiment, also enables auto-balancing of the inventory amongst Organizations, during the catalog period, based on, at least in part, real-time analysis of supply and demand and popularity trending of certain products with specific organizations.

### Organization Formation and Navigation

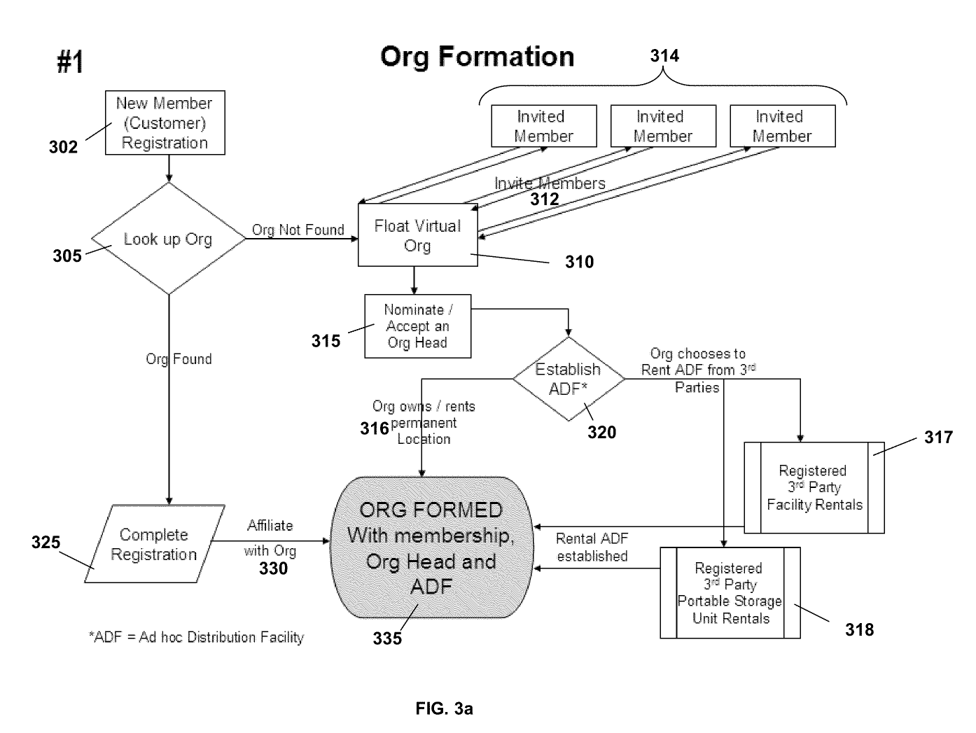

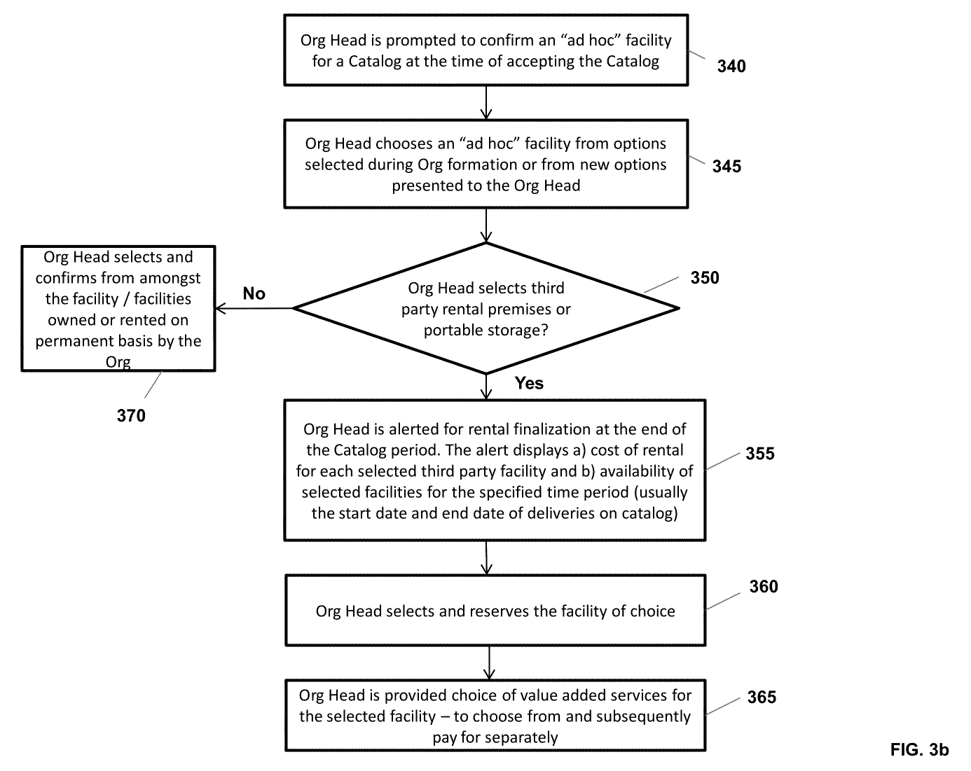

The processes involved in forming and registering an Organization on the e-commerce system will now be described in accordance with one embodiment. FIG. 3A is a flow diagram illustrating exemplary steps related to formation of an Organization. Referring now to FIG. 3A, a new customer 302 indicates a desire to register with the e-commerce system of the present invention; and, as one of the processes of self-registration, new customer 302 is now taking steps to affiliate with one or more Organizations registered with the e-commerce system. At step 305, the new customer 302 determines if an Organization of their choice is already formed and registered on the e-commerce system to affiliate with. If not, the customer 302 creates 310 a virtual Organization and invites 312 potentially interested members 314 to join the new virtual organization. At this stage the e-commerce system may enforce a “minimum membership” (number of members) that needs to be attained to qualify a virtual Organization to proceed to the next step.

If minimum membership is enforced, and obtained, in accordance with an aspect of the present invention, all or a majority of members of the Organization nominate and/or accept, in optional step 315, one of the members to be the Head of the Organization (hereinafter referred to as “Org Head”). Step 315 is optional because in one embodiment, the customer 302 who creates the virtual Organization, also known as the “founding member”, can identify himself/herself as the permanent Org Head, at the stage of Organization creation 310. In this case, step 315 of further nomination or acceptance of Org Head is not required. Also, the founding member remains the Org Head of that Organization for the duration of the existence of the Organization on the e-commerce system of the present invention.

The Org Head is entrusted to perform at least the following responsibilities 1) to review, select and approve the product catalogs posted to the concerned Organization; 2) to define the products that can be offered/sold to the Organization; 3) to acknowledge merchandize delivery on behalf of the members in case of campus catalogs and thereby release the e-commerce system of any liabilities; and 4) to establish and manage at least one “ad hoc” distribution facility where merchandize is received, in case of Campus Catalogs from the seller and from where redistribution of products will be affected to the relevant members. An embodiment of the e-commerce system of the present invention allows following three types of “ad hoc” distribution centers: i) physical premises 316 owned or rented by the Organization on permanent basis; ii) physical premises 317 provided for rental by third parties registered on the e-commerce system; or iii) portable Storage Units 318 provided for rental by third parties registered on the e-commerce system. In one embodiment, the third party rental facilities 317 and 318 are owned and rented by Administrator of the e-commerce system of the present invention.

At step 320, the Org Head establishes/confirms at least one “ad hoc” distribution center indicating one or more of each or any combination of the three types of centers 316, 317 or 318. The “ad hoc” centers, registered with the system, are presented to the Org Head to choose from. In case the Org Head chooses multiple centers, he/she will have an option to select one of these chosen centers to be designated as default delivery locations. In one embodiment, the Org Head can also qualify one or more third party rental facilities as “favorites”. The e-commerce system also prompts the Org Head to provide the physical address and other relevant details of the “ad hoc” center 316 owned or rented by the Organization. In the case of centers rented from third parties registered with the e-commerce system (317,318), such address and other details would already reside in the system as a result of registration of such third party centers available for renting. Thus, the virtual Organization is now formed 335.

If at step 305 the new customer finds that the Organization(s) (that the customer would like to be a member of) already exists registered on the e-commerce system, then the new customer completes 325 their self-registration and selects 330 the existing Organization(s) of choice for affiliation.

In one embodiment, the e-commerce system of the present invention allows the Organizations an ability to create Sub-Organizations (Sub-Orgs), where Sub-Orgs are branches or subsidiaries of an Organization, which may have a separate geographic locations and market profiles, but are managed and monitored through its main/parent Organization login.

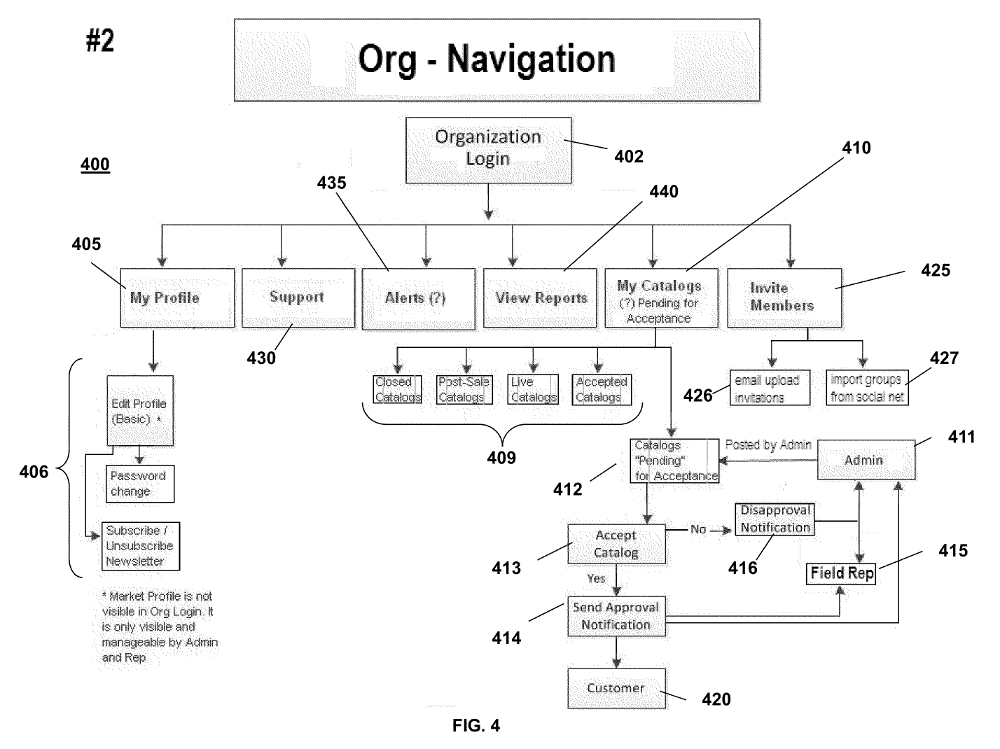

On successful formation and registration of an Organization, the Org Head gets access to a virtual Organization Console (Graphical User Interface) to use a plurality of relevant features and perform relevant functions. FIG. 4 illustrates exemplary functionalities or features-architecture of an Organization Console 400, that the Org Head gets access to after logging into 402 the system, in accordance with one embodiment. For example, the “My Profile” panel 405 allows management of a plurality of Organization related credentials 406 such as modification of Basic Profile of the Organization, change of login password, enable/disable subscription to any newsletters or other literature or freebies advertised, etc. The Basic Profile of the Organization comprises establishment of at least a unique Organization Name on the e-commerce system, login password and any other information that may be required by the system at the time of registration.

Persons of ordinary skill in the art should appreciate the difference between an Organization's Basic Profile and Market Profile. An organization's Basic Profile comprises credentials that are set-up by an Organization during their registration process. On the other hand, an organization's Market Profile comprises additional Organization profile information that is set-up by Field Representatives to complement the Organization's Basic Profile. This additional information, in one embodiment, comprises socio-economic factors, buying preferences, demographic and geographic attributes of the Organizations and its constituent members. The presence of such additional attributes (as Market Profile) enables Sellers to better target their products and/or to appropriate Organizations, in accordance with an aspect of the present invention. The “My Catalogs” panel 410 provides information related to catalogs of products/services posted, assigned or available to the Organization.

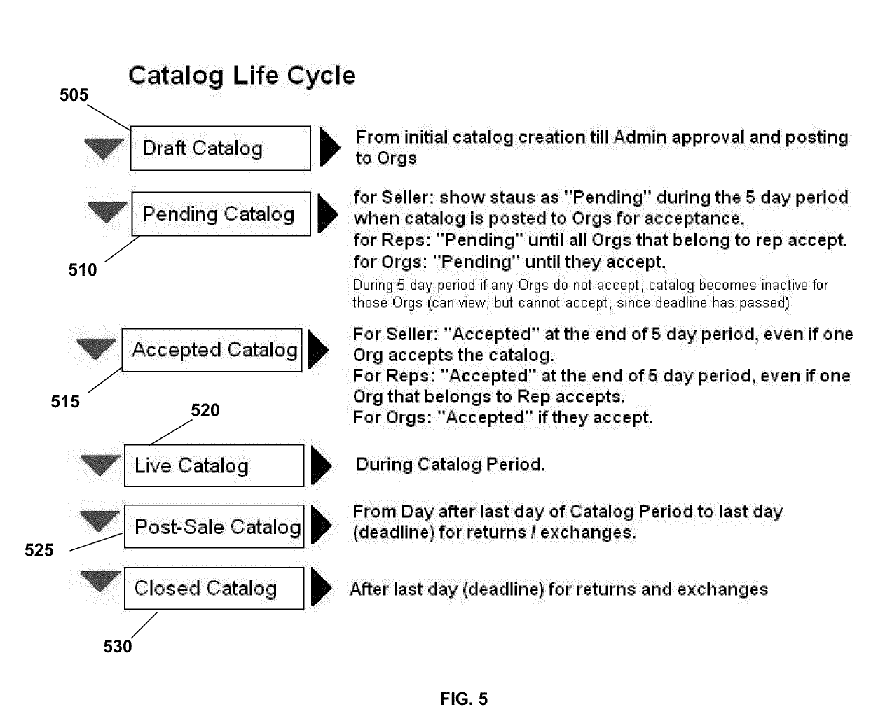

FIG. 5 shows the life cycle of a catalog of products/services in accordance with an embodiment. Referring to FIG. 5, a catalog is referred to as draft catalog 505 from the time when a seller/manufacturer creates a catalog until the Administrator approves and posts the catalog to at least one Organization. A pending catalog 510 is one for which status is shown as “pending”. In terms of Sellers, a catalog is pending during the review/acceptance period (that in one embodiment is 5 days, but can vary in alternate embodiments) when the catalog is posted to an Organization for review and acceptance. In terms of Field Representatives, a catalog is pending until all Organizations that belong to a Rep's portfolio accept the catalog. In terms of an Organization, a catalog is pending until the Organization accepts the catalog. In one embodiment, If certain Organizations do not accept a catalog during the review/acceptance period, then the catalog becomes inactive for those Organizations as a result of which they can now only view the catalog but can no longer accept (as the acceptance period/deadline is over).

An accepted catalog 515 is one for which status is shown as “accepted”. In terms of Sellers, an accepted catalog is one in which at the end of the review/acceptance period, at least one Organization (out of many Organizations to whom the catalog was posted or assigned to by the Administrator) accepts the catalog. In terms of Field Representatives, an accepted catalog is one in which at the end of the review/acceptance period, at least one Organization (out of many that belong to the portfolio of Organizations for the Rep) accepts the catalog. In terms of an Organization, an accepted catalog is one in which the organization itself has accepted they catalog.

In one embodiment a Seller/Manufacturer defines the catalog period—the duration which the seller's catalog is open online for purchase. Accordingly, a catalog status is termed as a live catalog 520 during the catalog period. A catalog is termed as a post-sale catalog 525 beginning the day after the last day of the catalog period to the last day (that is, the deadline) for any returns or exchanges of catalog products/services.

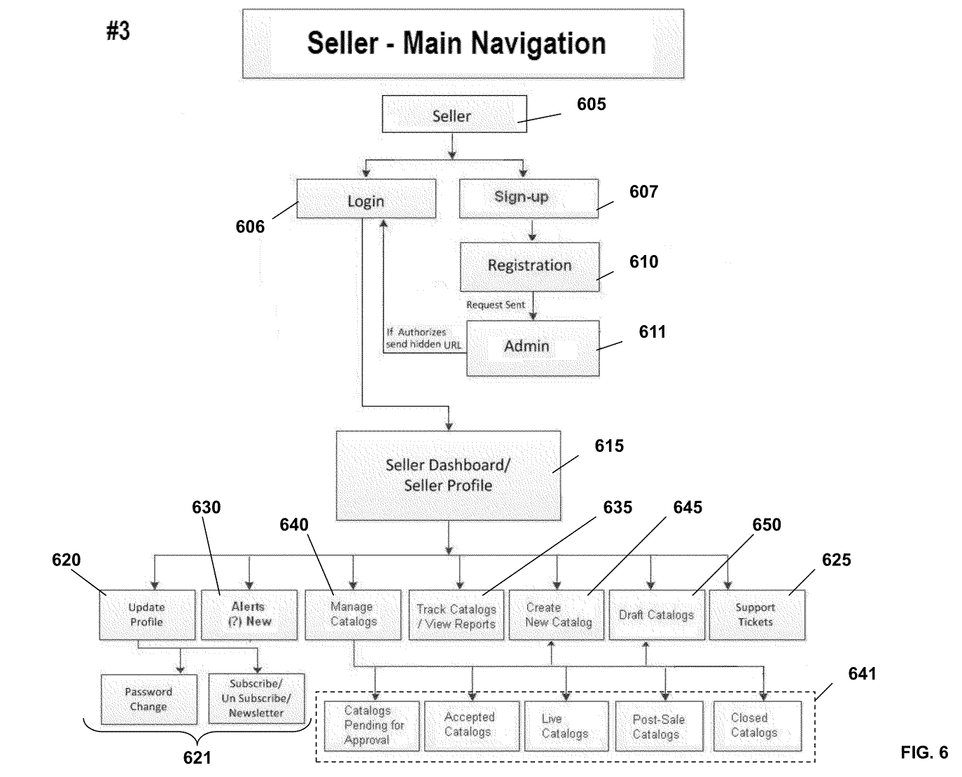

Finally, a catalog is said to be a closed catalog 530 after the last day (that is, the deadline) for returns or exchanges. The e-commerce system of the present invention enables Sellers to determine appropriate dates/deadlines at the time of creating/posting a catalog (such as, through create new catalogs step 645 of FIG. 6, described below), based on the type of catalog.

In one embodiment, in addition to Catalogs (Campus, Direct and/or Soft) approved and assigned to specific Orgs by the Administrator, the e-commerce system of the present invention also allows Sellers (with Administrator's approval) to post “Open Catalogs” in an area of the online e-commerce website that is accessible to all registered Orgs. These Open Catalogs appear online during their review/acceptance period (before they go Live). In an embodiment, certain Open Catalogs follow a cyclic pattern approved by the Administrator. In a cyclic pattern an Open Catalog re-appears online as a “new edition” each time the review/acceptance period of previous edition is over. Each cycle of the Open Catalog is automatically assigned a different Catalog ID for unique identification within the e-commerce system of the present invention. Orgs may visit the “Open Catalogs” area to browse, select and add/accept those catalogs without further approval from Admin.

Referring back to FIG. 4, the “My Catalogs” panel 410 provides status information on various catalogs 409 such as closed, post-sale, live, accepted and/or pending (as described with respect to FIG. 5 above). Specifically, the catalog that has been posted to an Organization by the Administrator 411 is shown as pending catalog(s) 412 awaiting acceptance by the Organization. If the catalog is accepted, at step 413, by the Organization, an approval notification 414 is automatically sent to the concerned Representative 415, members/customers 420 and the Administrator 411. If the catalog is not accepted, at step 413, a disapproval notification 416 is automatically sent to the concerned Representative 415 and the Administrator 411.

The “Invite Members” panel 425 allows users of the Organization Console 400 to invite new members to the Organization. Such invitations can be accomplished by uploading e-mail addresses 426 of potential invitees to the e-commerce system and sending invitations to these upload email addresses. The e-commerce system also enables invitations to be sent to groups 427 of people present on various social networking websites, such as, but not limited to, Facebook, Linkedin, Orkut, etc. Other features of the console 400 comprise a “Support” panel 430 that can be used to raise a support/helpline ticket to a Seller and/or Administrator for purposes such as queries, technical support, requesting additional information related to catalogs, request from members to Administrator for extension of catalog period, and the like. At the “alerts” panel 435 Organizations receive email alerts of new catalogs posted/assigned by the Administrator, for review/approval.

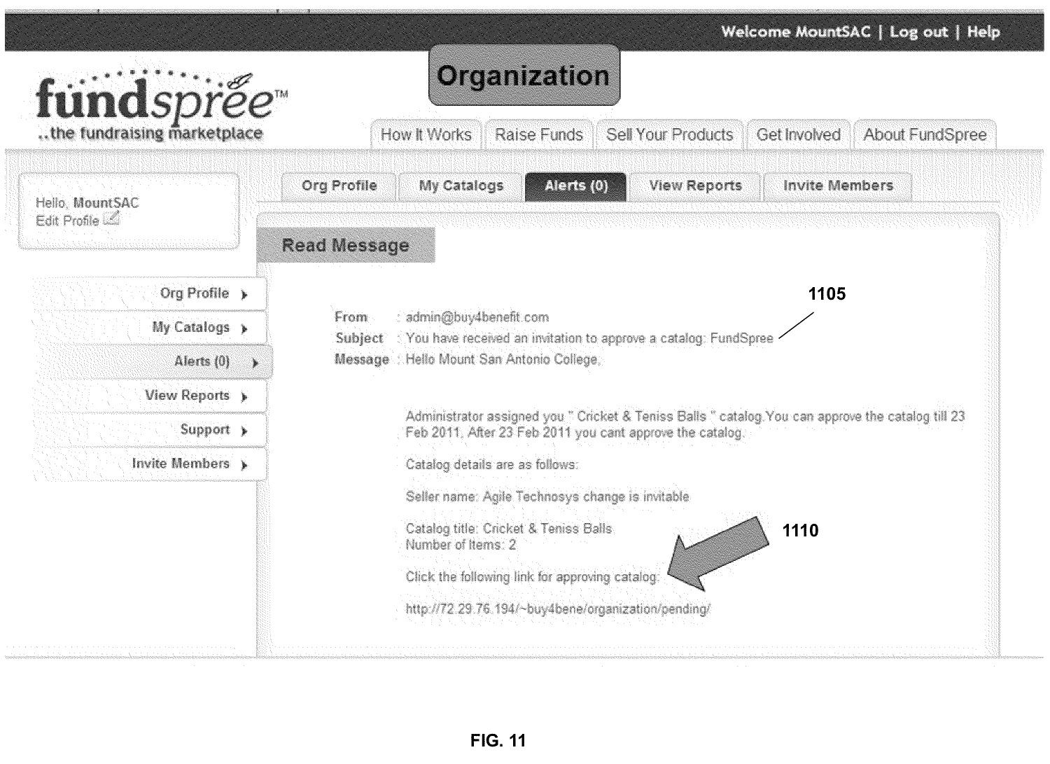

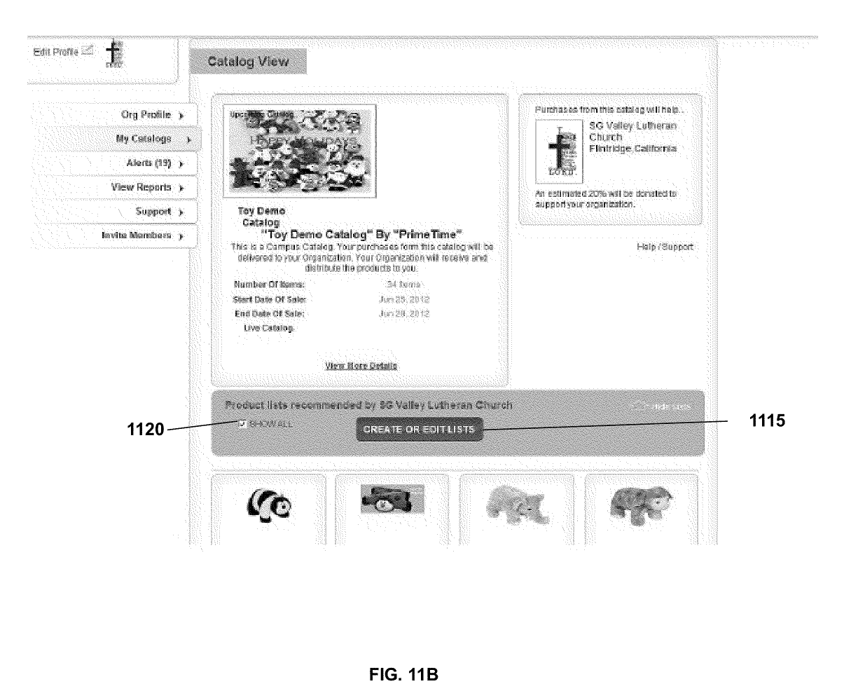

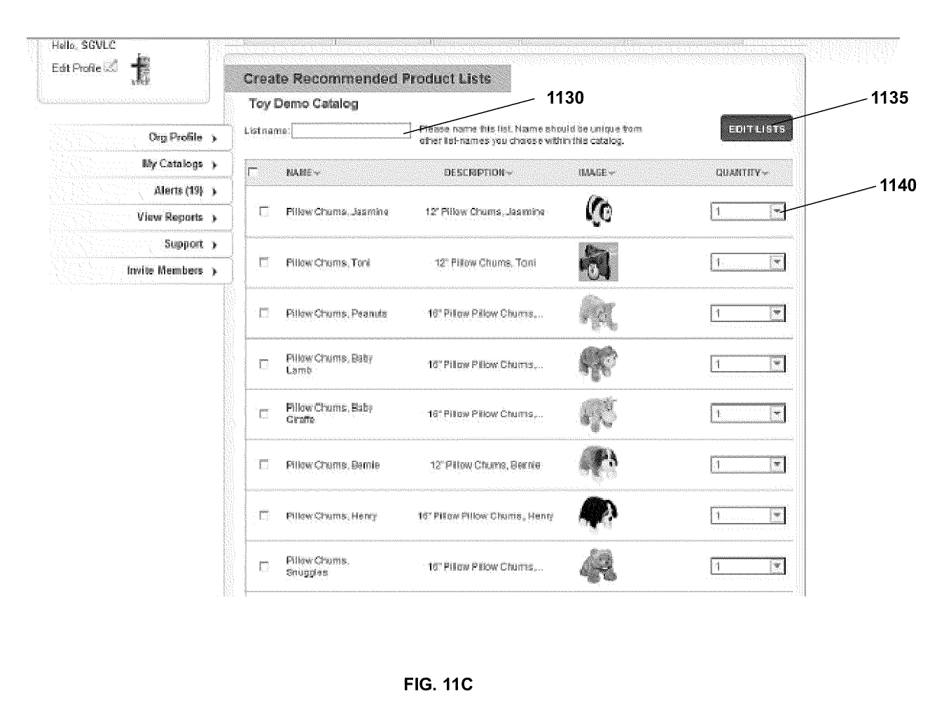

FIG. 11 is an exemplary GUI illustration (of the Organization Console 400 of FIG. 4) showing an example “alert” 1105 for a new catalog posted/assigned by the Administrator. The posted catalog can be approved by clicking the alert link 1110. It should be noted that, in one embodiment, customers/members associated with the Organization receive email alerts when the Organization accepts a catalog. In one embodiment, the Org Head can make printed paper notifications available for distribution to associated customers/members as an alert of the Organization accepting a catalog. Customers/members can view a catalog online, only after their Organization accepts it.

### Recommended Product List(s)

In another embodiment, and described in greater detail below, an Organization can establish or define recommended product lists for its members, as part of the catalog acceptance process so that the member/customer can add the recommended list(s) of products to their cart. Further, the customer can view and choose variants of a standardized item that appears in a recommended product list(s). In addition, the system ensures that duplicate items (items that may appear in multiple lists) are not added to the Customer's cart upon checkout.

As part of the catalog acceptance process, described above, Organizations have the option to create, edit, and publish a Recommended Products List (RPL) using on-line tools provided by the system of the present specification. The Recommended Product List function allows an Organization to set up, create, and manage electronic lists of products from catalogs that are accepted by an Organization. Thus, an Organization can communicate product recommendations to its members. For example, and by way of example only, in the case where an Organization is a school, the Organization can recommend a list of products for Customers based upon a grade level or classroom requirements.

Once a catalog is accepted, an organization can create at least one electronic list by selecting products from that accepted catalog. FIG. 11B is an illustration of an exemplary GUI showing a catalog page embedded with the Recommended Products List capability, as viewed by an Organization. As shown in FIG. 11B, button 1115 is provided to allow an Organization to create or edit lists. Further, “Show All” button 1120 is provided to allow an Organization to view all lists in a default view.

FIG. 11C is an illustration of an exemplary GUI showing a typical list creation template used by an Organization in the Recommended Products List process. In one embodiment, a list can be assigned a unique name. As shown in FIG. 11C, area 1130 is provided for inputting or editing a list name. In one embodiment, lists can be added or deleted at any time, by selecting “Edit Lists” button 1135. In one embodiment, an Organization can specify a recommended quantity of each product selected for each list, by using drop-down quantity selection menu 1140. In one embodiment, the quantity value of a specific item can be set to “shared item”. This is in the case where a product from an accepted catalog is part of more than one list and the Organization wants to establish a limit on the cumulative recommended quantity of any specific item on a catalog, in order to prevent its members from buying excessive amounts of that particular item due to its occurrence on more than one list. For example, if the recommended quantity value is 1 and the Organization wants to prevent its members from purchasing more than 1 item, the Organization can set the Quantity value as a shared item. When the quantity of a specific item is set as a “shared item”, the system prevents duplication and excessive ordering of that item by its members, who may be purchasing according to multiple lists. In one embodiment, in case a customer is ordering from multiple lists and requires duplicate items, the customer can manually change the quantity on at least one recommended list, as described below.

In one embodiment, products within recommended product lists can be organized by name, description, image, or quantity.

In one embodiment, when an Organization completes the creation of at least one list, the system of the present specification identifies items from the catalog that are not featured in any of the created lists (not specifically recommended by the Org), and automatically compiles then as a list entitled “Additional Products”. This list is then displayed along with other created lists.

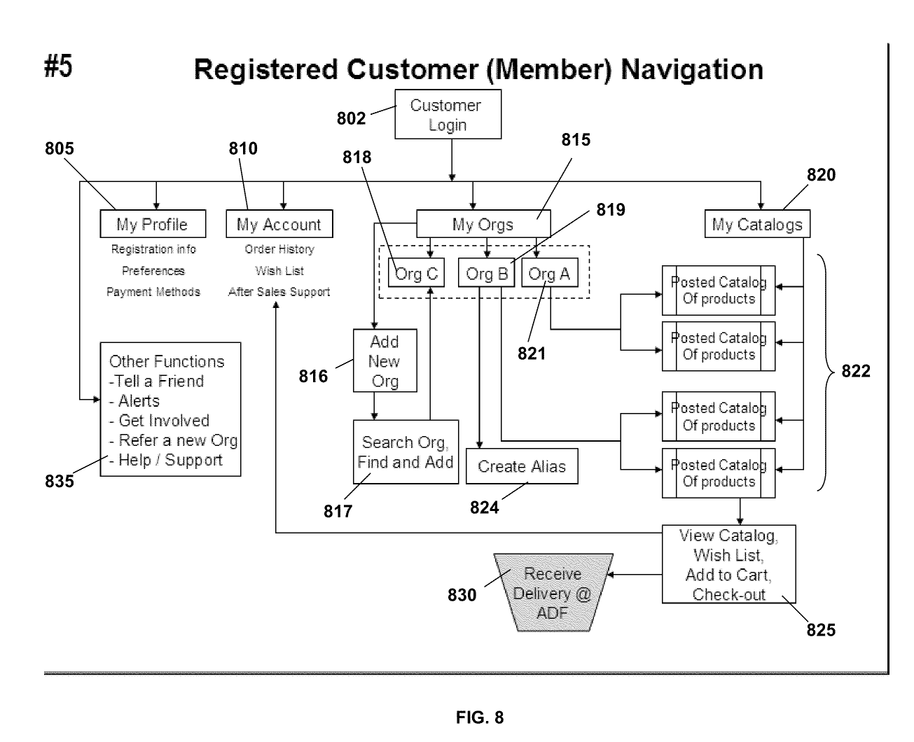

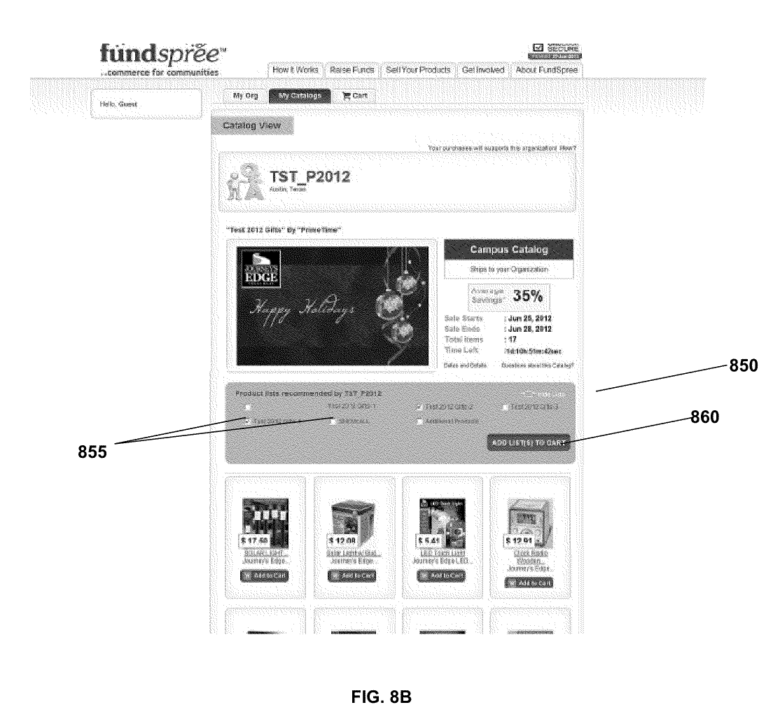

As described in detail below with respect to FIG. 8B, the customer is able to view the lists embedded in the customer's Catalog View page.

### Ad-Hoc Facility Confirmation

In addition, the present specification relates to a system in which an Organization can choose a size and location of a facility and receive “pre-packaged” retail platforms for equipment and “ad hoc” facility establishment. In accordance with an aspect of the present invention, the Org Head must confirm an “ad hoc” facility for a Catalog at the time of accepting the Catalog. Referring to the flowchart of FIG. 3B, the Org Head is prompted 340 to confirm an “ad hoc” facility for a Catalog at the time of accepting the Catalog. The Org Head then chooses 345 an “ad hoc” facility from either the options selected during Org formation or from new options presented. If the Org Head selects 350 third party rental premises or portable storage, then he/she is alerted 355 for rental finalization at the end of the Catalog period. In one embodiment, the e-commerce system of the present invention calculates the volume of goods/products purchased by the members of the Organization and displays the cost of rental of each listed facility according to prices pre-established by third party vendors. The system also displays availability of listed third party facilities for the specified time period (usually the period from start date to the end date of deliveries on Catalog). Based on at least a combination of rental cost and availability, the Org Head selects and reserves 360 the facility of choice on the system. Thereafter, the Org Head is presented 365 with of a plurality of value added services to choose from and pay separately—for the facility chosen at step 360. On the other hand, if the Org Head does not select a third party rental premise or portable storage, at step 350, then he/she is prompted 370 to select and confirm a facility (from a single or multiple facilities) owned or rented on a permanent basis by the Org.

The plurality of value added services presented at step 365 are targeted at assisting and enabling the Org to efficiently manage the receiving, accounting and distribution of products at third party rental premises or portable storage facilities. These value added services comprise product handling and storage/display hardware, equipment for rental; computer terminal for rental with built-in inventory module, virtual payment terminal, refund management and returned/defective merchandise logging; decorating and signage supplies package for the ad-hoc facility; loss and theft insurance and other services to help the Org manage products/business at the facility as would be advantageously evident to persons of ordinary skill in the art. In one embodiment, the third party rental facilities are accessible through entry code which is valid only for the duration of the rental. The e-commerce system of the present invention sends such entry code to the Org (such as by email, mobile communication). If computer terminal is rented, the e-commerce system remotely updates the computer terminal (at the ad-hoc facility) with necessary data relevant to distribution routine to be undertaken by the Org. Decorative supplies are shipped to the ad-hoc facility for use. Plurality of product handling and storage/display hardware and equipment are accessible within the facility by entering separate access code (which code is either provided at the facility or emailed to the Org earlier). Thus, with the use of value added services, in accordance with one embodiment, the Org is able to access the third party rental facility at the beginning of rental period, schedule and receive delivery from Seller, decorate the facility, sort & set-up inventory, distribute product and use computer terminal for accounting/reporting/refund requests. At the end of rental period Org is required to vacate the facility. If required, such as due to some inventory remaining behind in the facility, Org may log a special request in the rented computer terminal for extended rental of the facility space.

Referring back to FIG. 4, Organizations can view relevant reports (described under section ‘Reports’), through the “Reports” panel 440, during and after the catalog period.

### Reports

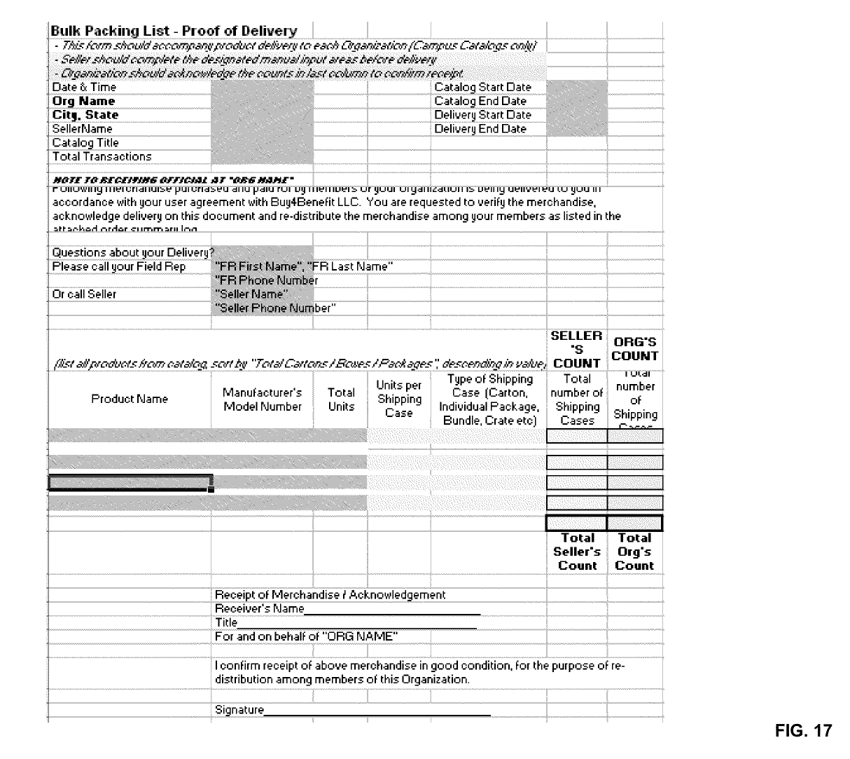

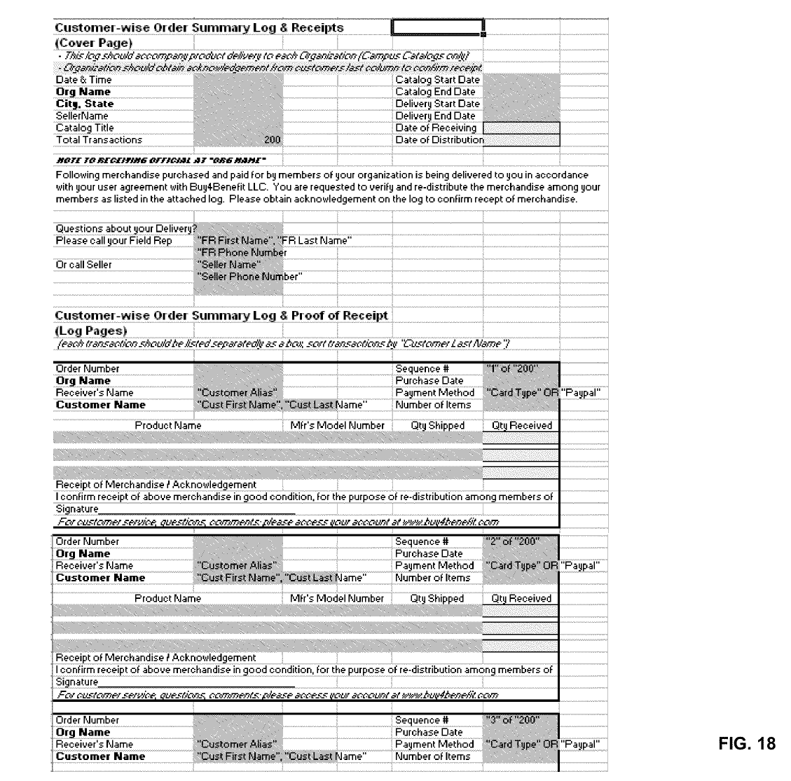

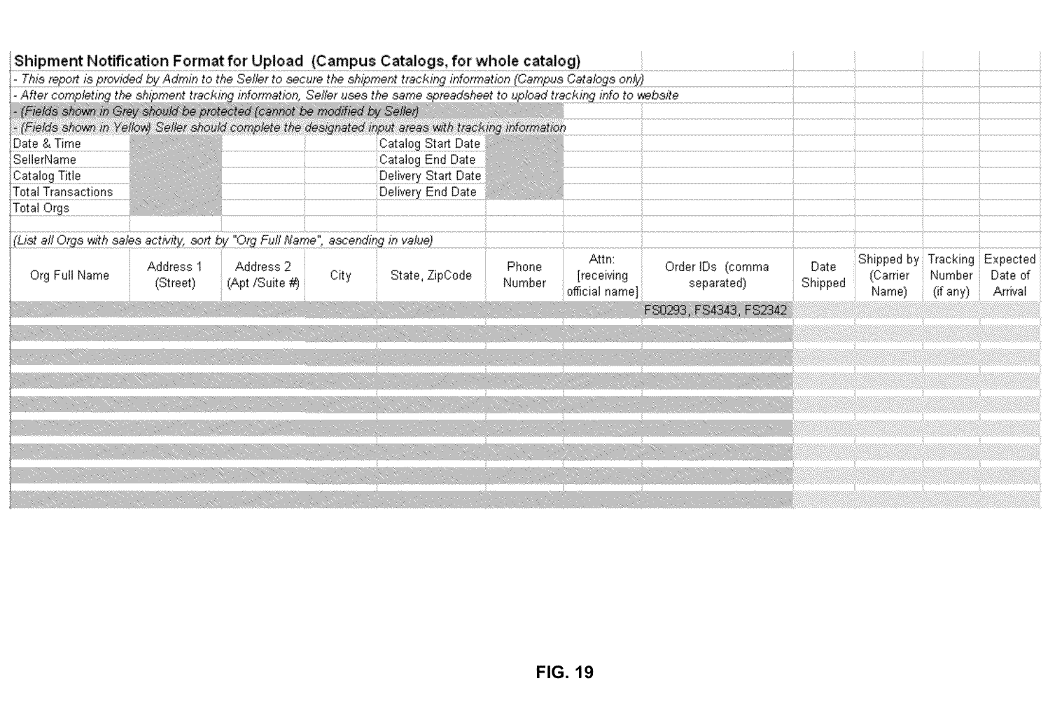

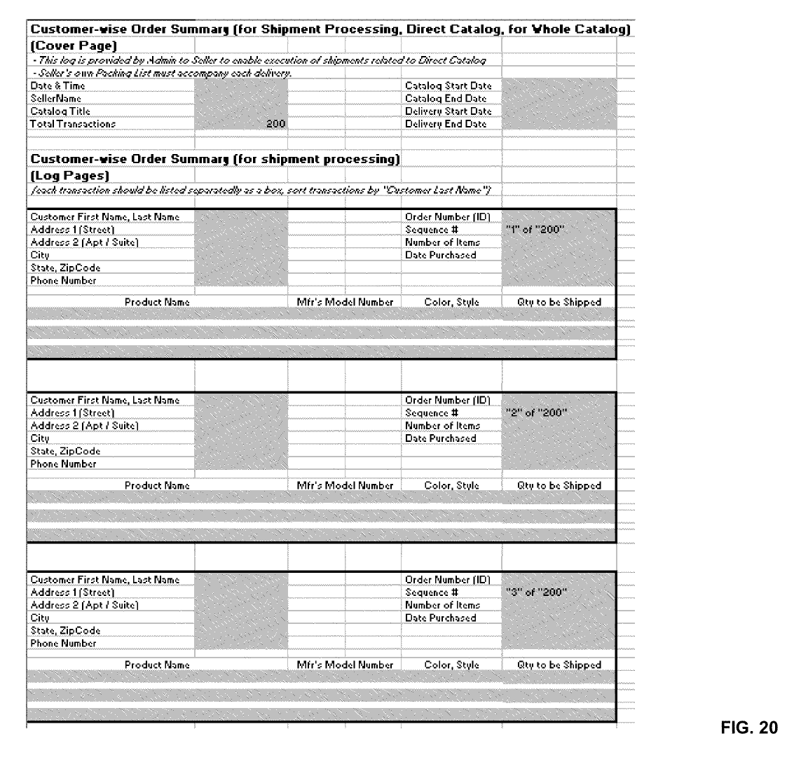

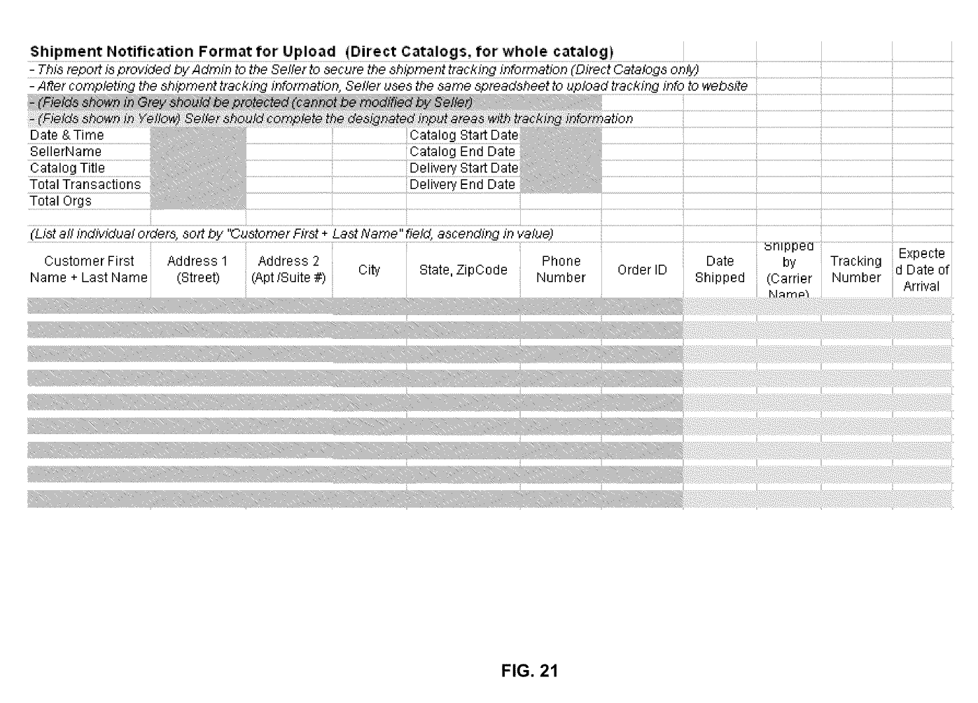

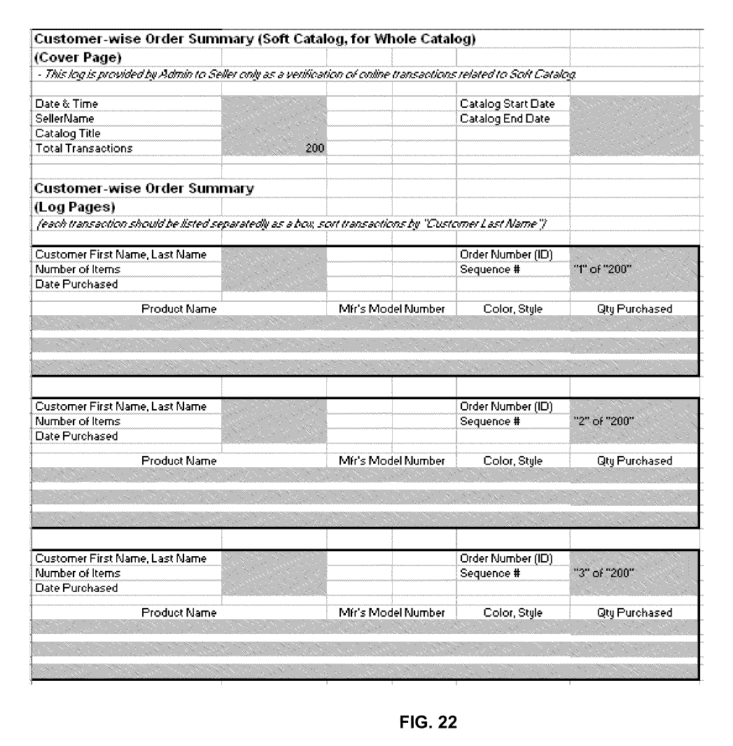

The e-commerce system of the present invention also generates a plurality of reports based on various metrics and transactions that it monitors. In one embodiment, these reports are broadly categorized as follows:
a) Internal reports, which are, in one embodiment, system-generated reports that are part of a Management Information System (MIS) for use internally by the e-commerce business/establishment for transaction audit and business analyses purposes. Examples of such MIS reports, in accordance with the type of catalog, comprise:
   i. Campus Catalog Internal Reports, which include, but are not limited to, a bulk packing list by the Organization and Proof of Delivery report, shown in FIG. 17 and later described; a customer-based order summary log and receipts report, shown in FIG. 18 and later described; and a Shipment Notification Format for Upload, shown in FIG. 19.
   ii. Direct Catalog Internal Reports, which include, but are not limited to, a customer-based order summary report, shown in FIG. 20 and a Shipment Notification Format for Upload, shown in FIG. 21.
   iii. Soft Catalog Internal Reports, which include, but are not limited to a customer-based order summary report, shown in FIG. 22.

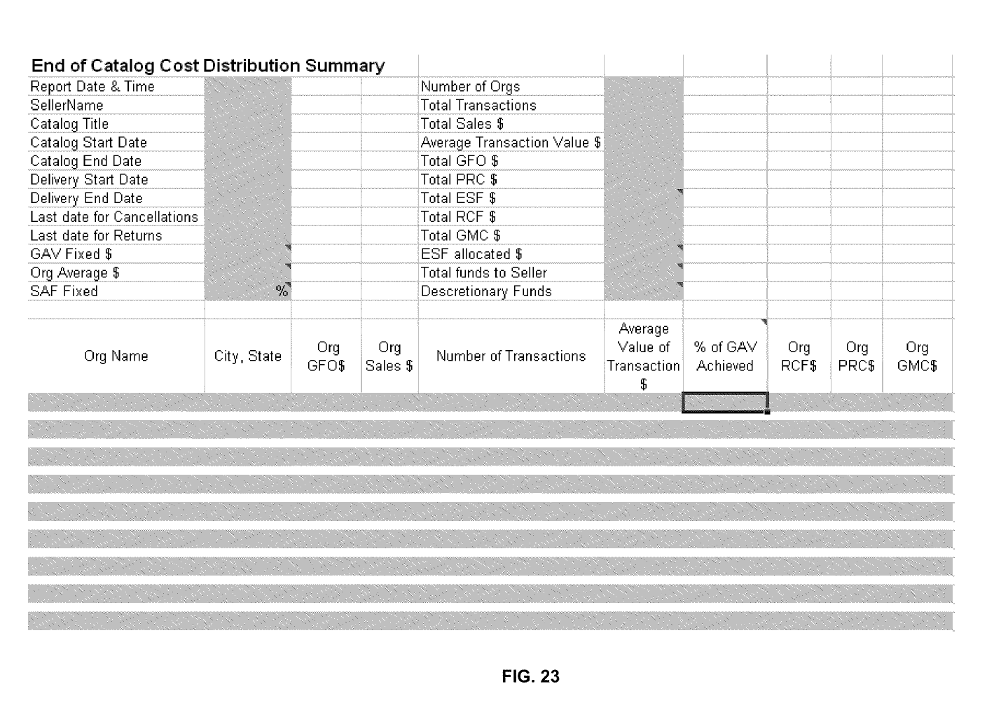

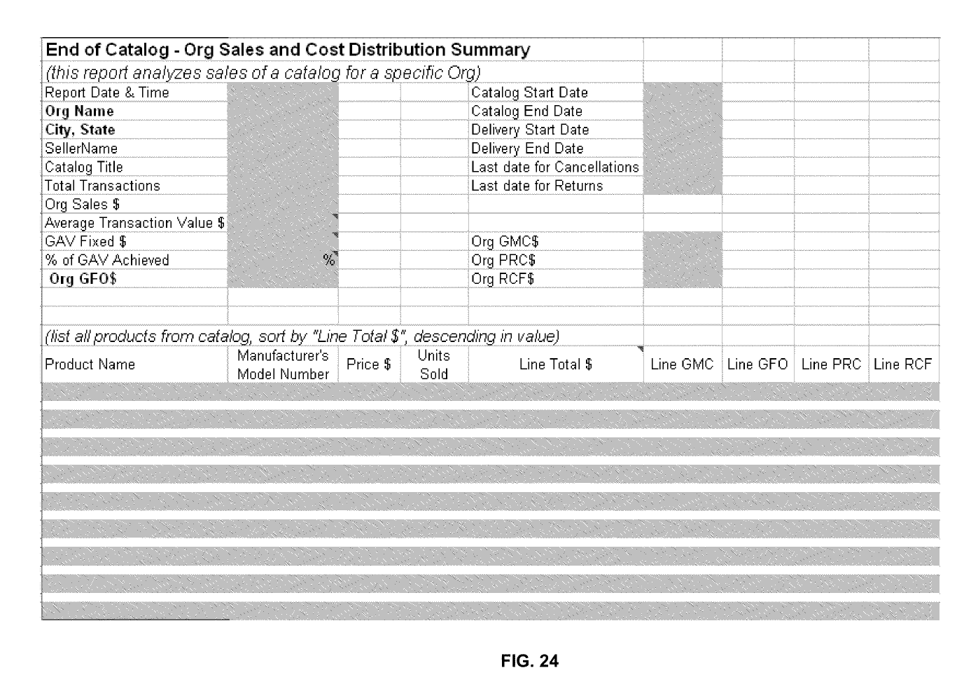

There are also MIS reports that are applicable to and can be generated for all types of catalogs. Examples of such reports comprise, but are not limited to End of Catalog Cost Distribution Summary Reports (shown in FIG. 23) and End of Catalog Organization Sales and Cost Distribution Summary Reports (shown in FIG. 24).

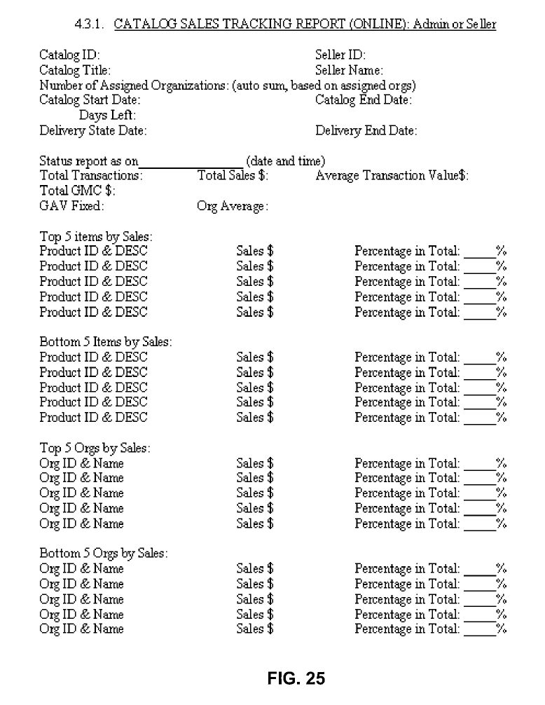

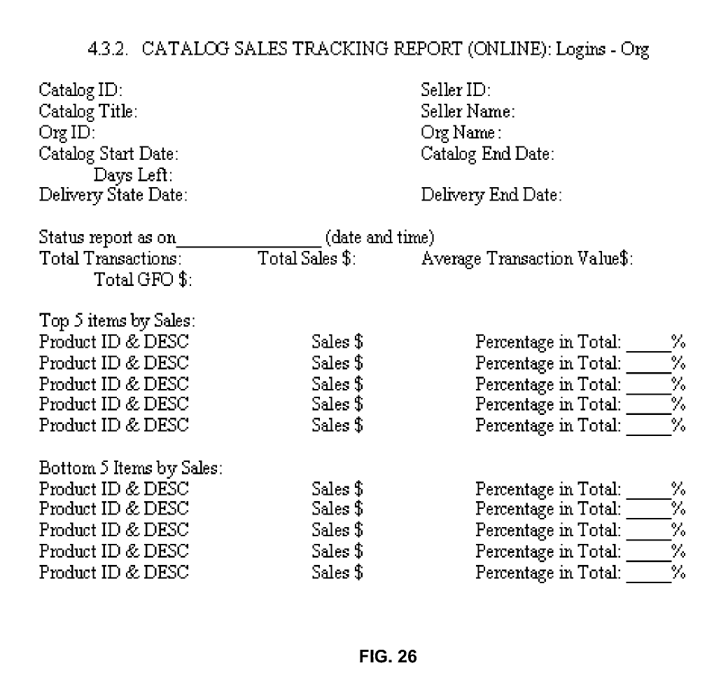

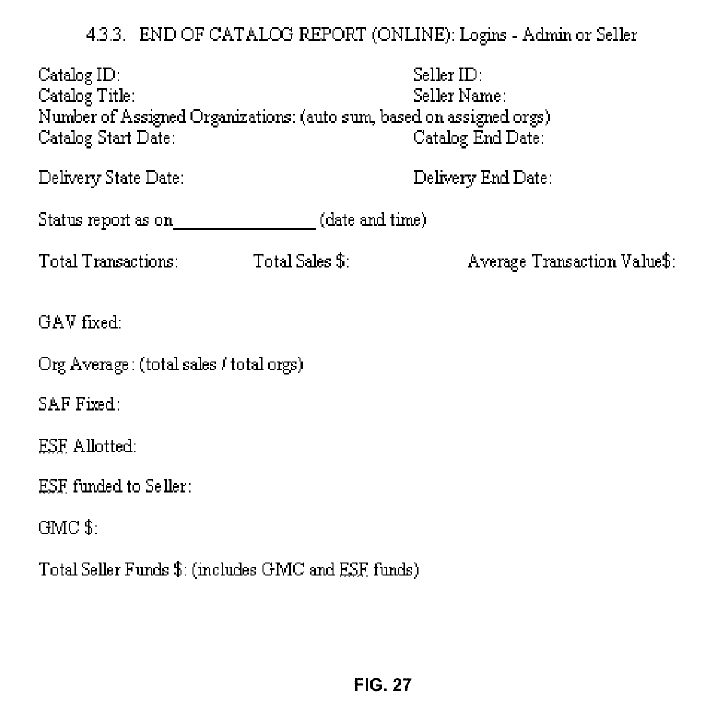

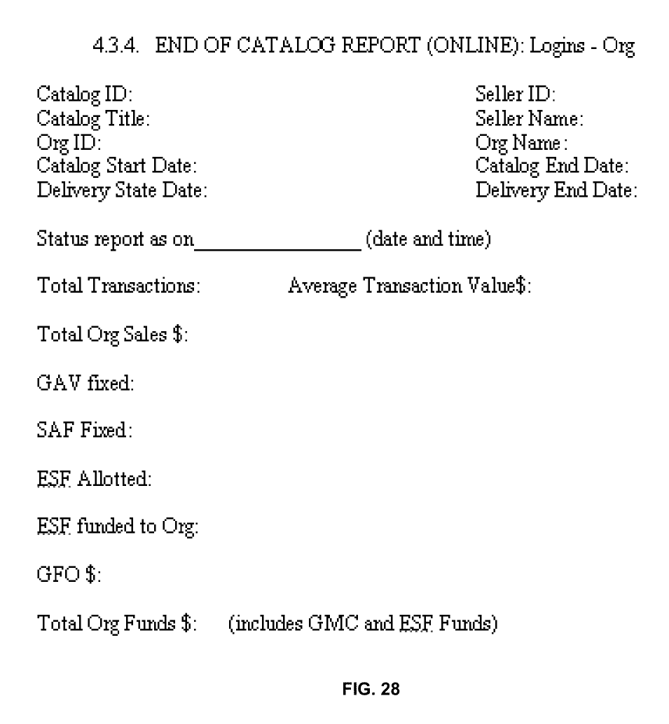

These reports can be used for various purposes and are not limited to the example described herein. For example, an End of Catalog Organization Sales Summary report can be tracked over a defined cycle/period of time for the e-commerce system to automatically assign ratings to the Organizations. These ratings are then accessible/viewable by Sellers.
b) External Reports, which are, in one embodiment, system-generated reports that are available for online access by the Sellers, Administrator and Organizations (Org Head) depending upon content and use. Examples of such report formats comprise, but are not limited to:
   i. Catalog sales tracking report, for Administrator and/or Sellers, as shown in FIG. 25;
   ii. Catalog sales tracking report, for Organizations, as shown in FIG. 26;
   iii. End of catalog report, for Administrator or Sellers, as shown in FIG. 27;
   iv. End of catalog report, for Organizations, as shown in FIG. 28.

Persons of ordinary skill in the art should appreciate that the type of information to be tracked and reported is customizable and can vary depending upon objectives. For example, it may be quite useful for the Sellers and Representatives to know buying patterns across socio-economic and demographic profiles (Market Profiles) of members of the Organizations. This will allow Sellers to pitch relevant products/services to those buyers who are most likely to buy those products/services, resulting in high purchase volumes resulting in potentially high derived cost savings to be offered to buyers, which in turn, means higher donations to the Organizations. This is desirable in accordance with an aspect of the present invention. In fact, Sellers can even strive to customize their catalogs depending upon Market Profile attributes of Organizations in future.

### Seller Navigation and Catalog Management

The processes involved in registration and navigation of a Seller on the e-commerce system will now be described in accordance with an embodiment. FIG. 6 is a flow diagram illustrating tasks related to registration and other navigation functionalities available to a Seller. Referring now to FIG. 6, the Seller 605 can either login 606 if already registered or can sign-up 607 for registration. Sign-up process 607 may require the Seller to provide necessary credentials and a valid e-mail address as would be evident to persons of ordinary skill in the art. The seller registration request 610 is sent to the Administrator 611 for acceptance/authorization. As part of authorization, in one embodiment, the Administrator sends a confidential URL to the Seller 605 that allows the Seller to log into his dashboard 615. Alternatively, in one embodiment, the Administrator can also register a Seller, directly into the e-commerce system by creating a Seller account from Admin console and forwarding the login information to the newly registered Seller; this option may be used by Admin for certain categories of Sellers that Admin determines to be restricted or that require closer monitoring.

Upon successful login, the Seller 605 gets access to a virtual Seller dashboard 615 (Graphical User Interface) to use a plurality of relevant features. For example, the “Update Profile” panel 620 allows management of a plurality of Seller-related credentials 621 such as (but not limited to) change of login password, enable/disable subscription to any newsletters or other literature or freebies advertised, etc. A “Support” panel 625 can be used to raise a support/helpline ticket to the Administrator for purposes such as queries, technical support, additional information related to catalogs, intimation to Administrator for extension of catalog period, etc. At the “alerts” panel 630 Sellers receive email alerts, such as from the Administrator, Organizations, Reps or the Organization members. Again, the Seller 605 can view relevant reports (described under section ‘Reports’), through the “Reports” panel 635, during and after the catalog period.

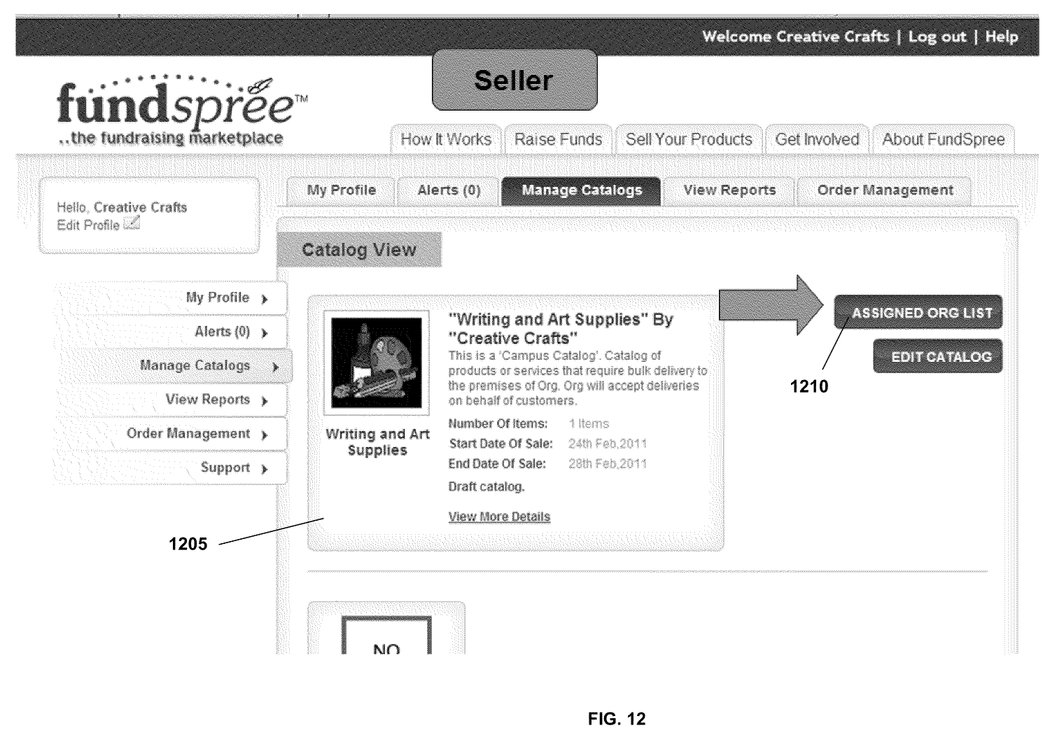

The “Manage Catalogs” panel 640 provides information to the Seller to manage status of various catalogs 641 such as closed, post-sale, live, accepted and/or pending. FIG. 12 shows an exemplary GUI where the Seller can view catalog 1205 along with the list 1210 of Organizations to which the catalog 1205 has been assigned to. Referring back to FIG. 6, the Seller can also create new catalogs 645 and manage draft catalogs 650.

FIG. 7 shows exemplary steps involved in creating a new catalog. Referring now to FIG. 7, the Seller 705 goes to “create new catalog” panel 710 to develop a new catalog. At step 706, the Seller may be asked to set-up various catalog related information/credentials such as defining the catalog type (Campus Catalog, Direct Catalog or Soft Catalog), date, time-line or catalog period, cost allocation, inventory (that is, the available units on each item/product for sale) and/or any other information that may be advantageously evident to persons of ordinary skill in the art. In one embodiment, the Seller has three options to create a new catalog:
1) by entering data manually on all items/products through web interface 711;
2) by bulk uploads using tab/comma delimited files (example, .CSV files) 712; and/or
3) by importing content 713 from previous or other catalogs and modifying them.

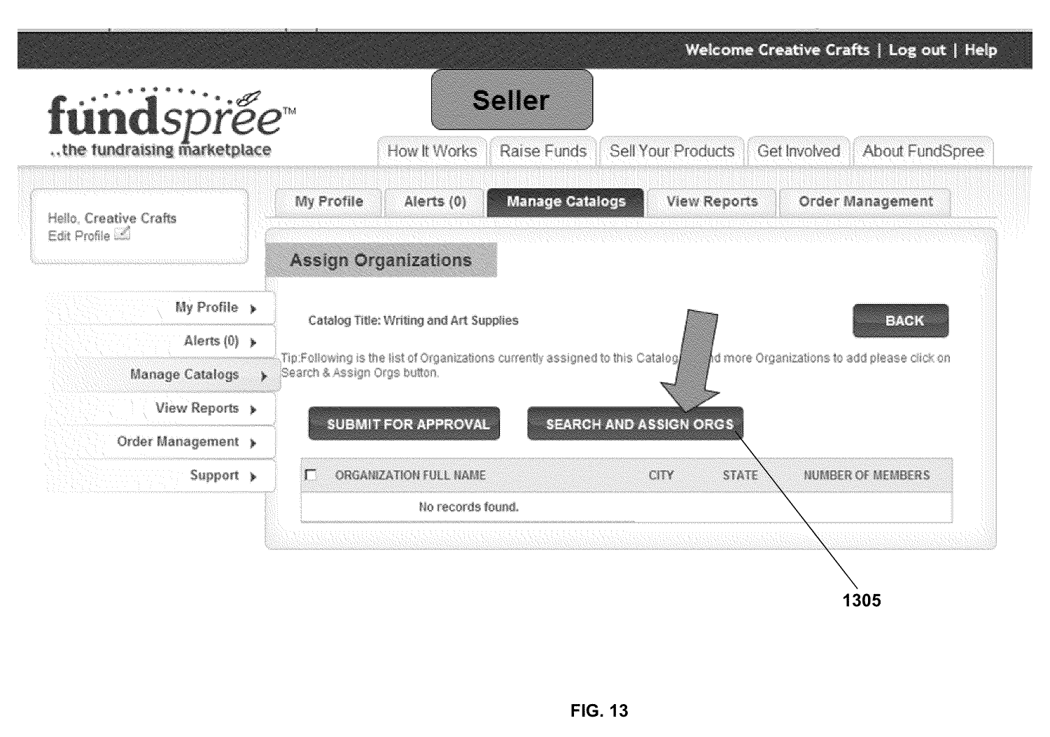

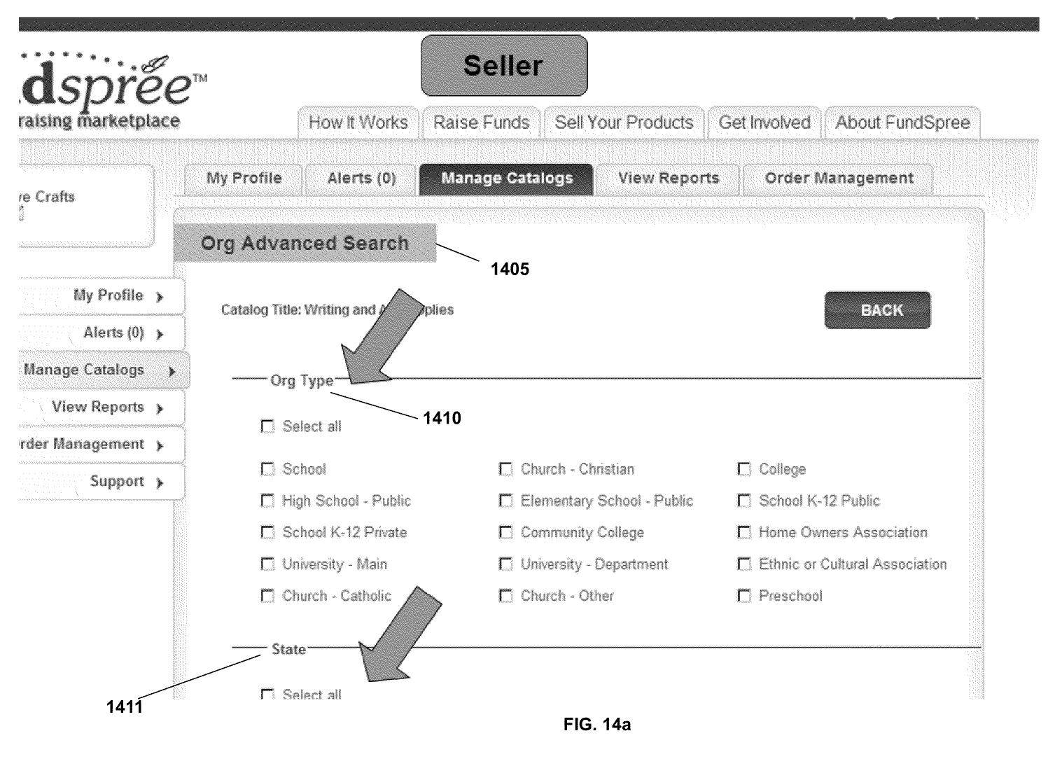

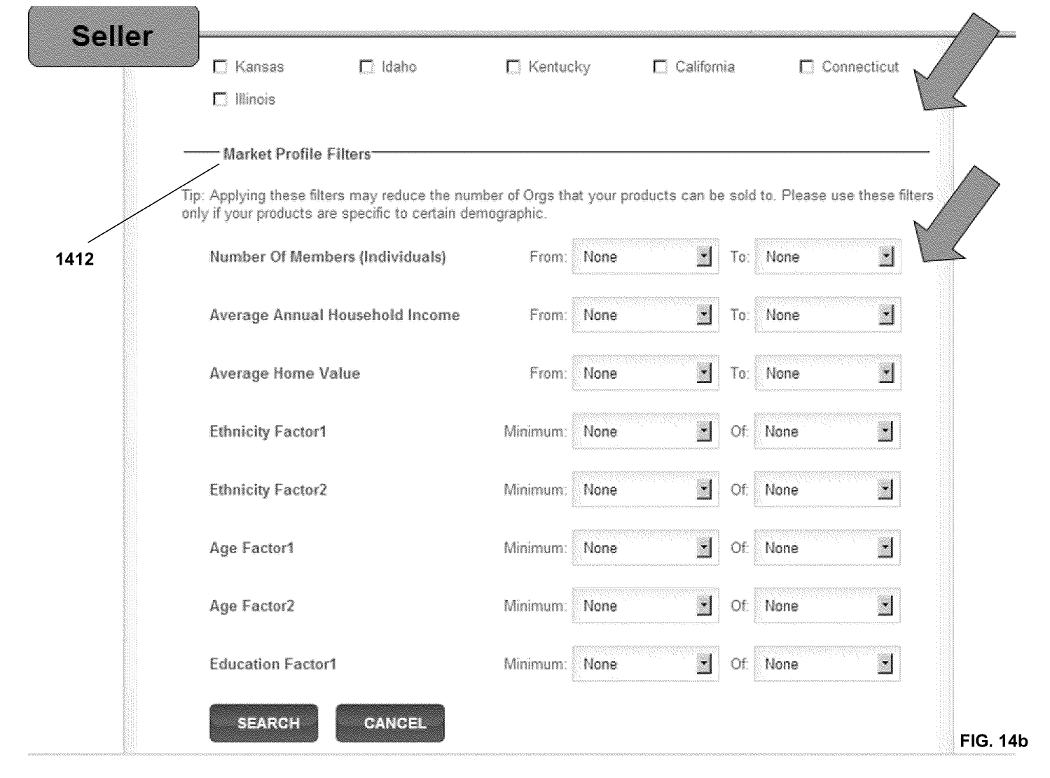

During new catalog set-up process, at step 707 the Seller is allowed to search registered Organizations based on parameters derived from Organizations' Basic Profile and Market profile. FIG. 13 shows a GUI where the Seller can simply click on icon 1305 to search and assign Organizations. FIGS. 14a, 14b show GUIs where, under an advance search feature 1405, the Seller can search Organizations based on various criteria such as Org Type 1410, state of the Organization 1411 and/or Market profile filters 1412 such as socio-economic and/or demographic data. Persons of ordinary skill in the art would appreciate that the functionality of searching Organizations by state 1411 can further be expanded to enable search by zip code and search radius.

Referring back to FIG. 7, the seller can review Organization search results, and select the Organizations of his choice to be assigned to the Catalog. It should be noted, however, that organizations are not notified at this stage, they will be notified only after the Administrator approves the seller's choice of organizations. At this stage the Seller can save 714 the draft of the new catalog for archiving in the “draft catalogs” panel 715. Next, information related to the new catalog, including the selected Organizations, is posted 708 as Draft Catalog by the Seller for Administrator's approval. During approval process the Administrator 730 can either approve all of Organization selections from Seller or delete/add to selection. If the Administrator 730 approves the catalog and all selected Organizations, the Administrator posts 720 the catalog to all selected Organizations for their review and approval. If the Organizations also approve, the catalog is deemed to be officially published 721 on the e-commerce system. Thereafter, the e-commerce system of the present invention enables approving Organizations to send out automatic alerts to inform their members/customers of the newly posted catalog.

However, if any of the Organizations disapprove the catalog (such as by raising concerns or ask for corrections, etc.) then the disapproval message is sent 722 to the Administrator who in turn conveys the message back to the Seller. Similarly, if the Administrator does not approve the Seller's catalog and/or suggests modifications to the catalog, the catalog is reposted 723 by the Administrator back to the Seller's draft catalogs panel 715 for review.

### Customer/Member Navigation

The processes involved in navigation of a registered Customer on the e-commerce system will now be described in accordance with an embodiment. FIG. 8 is a flow diagram illustrating navigation functionalities available to a Customer. Referring now to FIG. 8, when the registered customer logs into the e-commerce system, at step 802, he is presented with a customer console (GUI) that enables the customer to avail a plurality of functionalities. For example, the “My Profile” panel 805 allows the customer to manage/modify the customer's registration info (such as login password, email address, any other credentials), preferences and/or payment methods. The “My Account” panel 810 allows the customer to manage/view status of the customer's past purchase order history, browse or add to “wish list” of items and/or request for and check status of after sales support from Sellers. When customers land on an item that is “out of stock”, they are prompted to add the item to “wish list”. The relevant Seller is then automatically notified of aggregated wish-list items/quantities, say, on daily basis. Once the Seller adds inventory, item becomes in-stock again, and the concerned customers get automatically notified. Once customer purchases the item, the item is removed from wish-list.

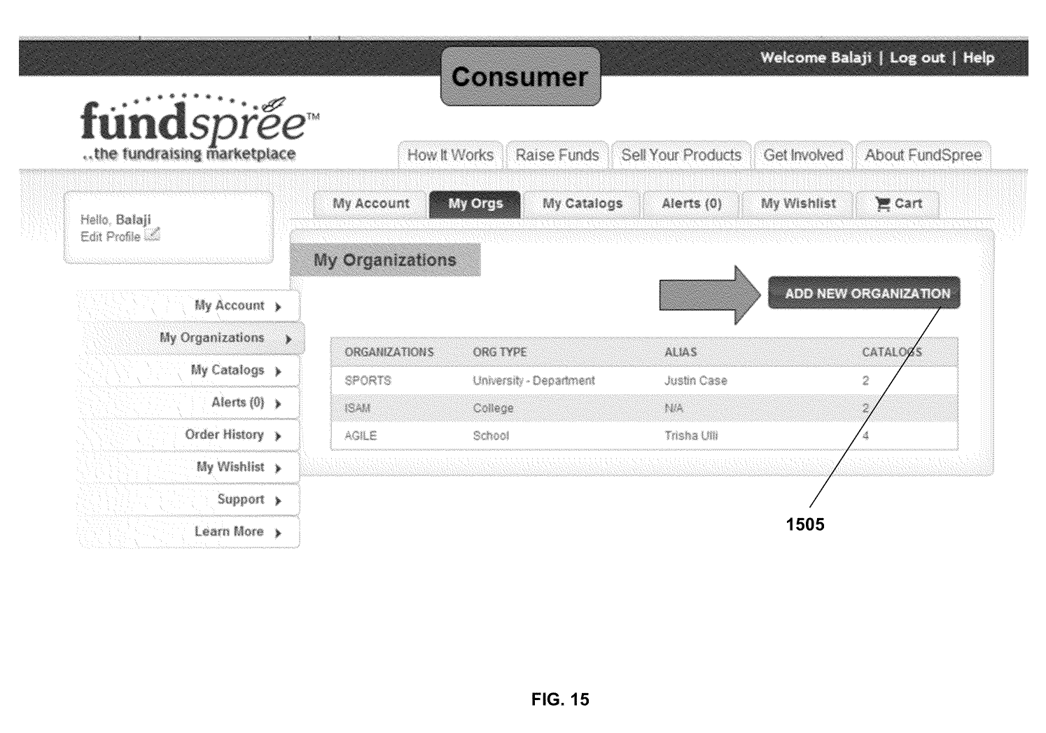

The “My Orgs” panel 815 allows the customer to view or manage aspects related to the Organizations that the customer is already affiliated with. In accordance with an aspect of the present invention, customers/members can establish affiliation to multiple Organizations by using the “Add new Org” functionality 816 (shown as icon 1505 in FIG. 15). Thus, the panel 815 allows the customer to be affiliated to a new Organization (apart from the ones he is already affiliated with). For example, the customer can, say, click an “Add new Org” icon 816 to search 817 registered Organizations based on parameters derived from Organizations' Basic Profile and/or Market profile (simple searching of Organizations based on Basic Profile and advanced searching of Organizations based on Market Profile have been described earlier with reference to FIGS. 13, 14a and 14b). From search results, the customer can select the Organization of choice and get affiliated thereto. The Organization, to which the customer thus becomes affiliated to, such as Org C 818, gets added on the panel 815.

The customer can also set-up an Alias, at step 824, which identifies his association with an Organization as “indirect membership”. For example, customer is a Parent, Organization is a School, and customer has a Student at School. Student name, in this case, may become Customer's Alias. It is important to note, in this example, that the Parent is merely an online purchaser and may not necessarily be a direct member of the School (that is the Organization). In this case, the online purchaser (that is the Parent) specifies an Alias to indicate identity of an actual direct member (the Student) of the School who will be the final recipient of the purchased goods. In one embodiment, the customer is prompted to enter the Alias (according to fields specified by the Organization) when adding specific types of Organizations (schools/colleges) to his profile at the time of registration. When customer begins to shop a catalog of an Organization where Aliases exist, he is prompted to confirm the Alias before proceeding to shop. The transaction is recorded with that specific Alias (and also reflected on, say, the purchase order summary when the customer checks-out of the e-commerce system).

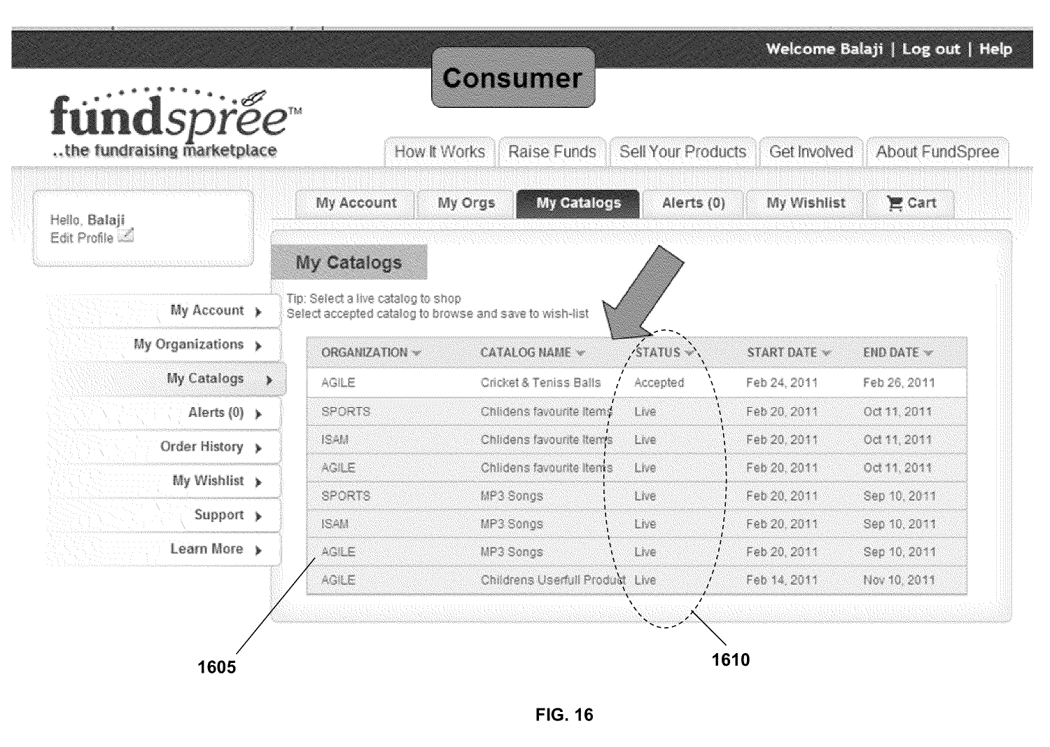

The catalogs 822 approved by the Organizations (to which the customer is affiliated with and therefore is a member of) and posted by the Organizations to the customer, can be viewed under the respective Organization tab/icons 818, 819, 821 or collectively under the “My Catalogs” panel 820 (FIG. 16 shows a GUI depicting posted catalogs 1605 along with information such as status 1610 of the catalogs). The customer can view/navigate the posted catalogs 822, purchase items online and check-out 825. The purchase orders are then sent to the respective Sellers. The customers may receive 830 ordered/purchased products through designated “ad hoc” distribution facilities. In case of Direct and Soft Catalogs, product is delivered directly from Seller to each Customer, without usage of ad hoc distribution facilities.

In another embodiment, as described in detail above with respect to FIGS. 11B and 11C, an Organization can establish or define recommended product lists for its members/customers, as part of the catalog acceptance process so that the member/customer can add the recommended list(s) of products to their cart. Further, the customer can view and choose variants of a standardized item that appears in recommended product list(s).

FIG. 8B is an exemplary GUI illustrating a catalog view available to a Customer featuring a Recommended Products List. As shown in FIG. 8B, a customer is able to view the embedded and created lists in the Catalog View page 850. By using at least one checkbox 855 to select at least one list or a “Show All” view of lists, the customer can filter the display of products; therefore, the products displayed for customers to view will always match the selection of lists by the customer. By selecting at least one list via a checkbox 855, the customer can then select button 860 to add the at least one list to the cart. Thus, the entire set of products and respective quantities from selected recommended product list(s) are added to the customer's cart directly at one time.

When the customer selects the recommended product lists(s) on the Catalog View page and uses the “Add List(s) to Cart” button 860, the system of the present specification prompts the customer to “Continue Shopping” so that they may browse an “Additional Products” list or “View Cart” so that they can continue with the purchase process. If the customer chooses the “View Cart” function, they are able to view alternate product choices, including but not limited to color/fashion variants, review and adjust quantities of products in the list, and even delete items as needed from the list.

In another optional embodiment, the customer is able to view alternate product choices, including but not limited to color/fashion variants, in an intermediate step, upon selecting “Add List(s) to Cart” button 860. Once the variants are selected, the system of the present specification prompts the customer to “Continue Shopping” so that they may browse an “Additional Products” list or “View Cart” so that they can continue with the purchase process.

If the customer chooses to “Continue Shopping”, this enables the Customer to revert to the Catalog View and browse products from the “Additional Products” list that may contain products not on the recommended products list. In addition, the Customer may add individual items from the catalog.

A plurality of other functionalities 835 are also available to the customer. For example, tell-a-friend feature that allows the customer to send emails related to products/services catalogs recommendations. The alerts feature allows the customer to get email alerts from his Organizations when they accept/approve and post catalogs to the customer. Help/support feature allows customers to raise helpline tickets to Sellers and/or Administrator who respond by clicking on the corresponding support/help link appearing on their respective consoles. In one embodiment, if while searching for Organizations, to get affiliated to, the customer does not find an Organization of his choice, he may be prompted to complete an Organization Referral Form wherein he can provide relevant details of the Organization of his choice.

### Field Representatives' Navigation

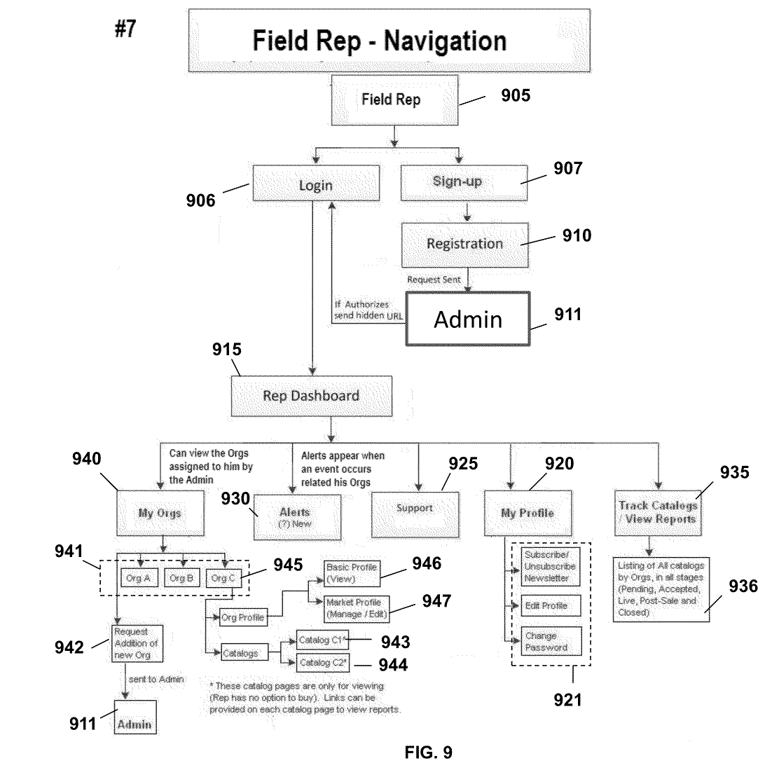

The processes involved in registration and navigation of a Field Representative on the e-commerce system will now be described in accordance with an embodiment. FIG. 9 is a flow diagram illustrating tasks related to registration and other navigation functionalities available to a Representative. Referring now to FIG. 9, the Representative 905 can either login 906 in case he is already registered or can sign-up 907 for registration. Sign-up process 907 may require the Representative to provide necessary credentials, email address and any other details as would be evident to persons of ordinary skill in the art. The Representative's registration request 910 is sent to the Administrator 911 (for example, as an email or web-link alert) for acceptance/authorization. As part of authorization, in one embodiment, the Administrator 911 sends a confidential URL to the Representative 905 that allows the Representative to log into his dashboard 915.

On successful login, the Representative 905 gets access to a virtual dashboard 915 (Graphical User Interface) to use a plurality of relevant features. For example, the “My Profile” panel 920 allows management of a plurality of Representative related credentials 921 such as (but not limited to) change of login password, edit self-profile, enable/disable subscription to any newsletters or other literature or freebies advertised, etc. A “Support” panel 925 can be used to raise a support/helpline ticket to the Administrator for purposes such as queries, technical support, intimation to Administrator for extension of catalog period, etc. At the “alerts” panel 930 the Representative receives email or web-link alerts, such as from the Administrator when an event related to the Representative's Organization occurs, example, when a new catalog is posted/assigned by Administrator to any of the Organizations in the Representative's portfolio; again, for Campus Catalogs, the Representative could receive alerts when the corresponding Seller has processed purchase orders and submits a shipment/delivery status or summary online. The Representative 905 can view reports, tracking status of lists 936 of all catalogs by portfolio Organizations, through the “Track Catalogs/View Reports” panel 935, during and after the catalog period.

The “My Orgs” panel 940 allows the Representative to view or manage aspects related to the Organizations 941 that the Representative has been assigned to by the Administrator. Representatives can be assigned multiple Organizations by the Administrator. In one embodiment, Representatives can get affiliated to a new Organization of choice by sending a request 942 to the Administrator 911 for adding the new Organization of choice. Representatives can view catalogs for each of the Organizations that they are affiliated with—for example, catalogs 943, 944 for Organization 945 are viewable by the Representative. In one embodiment, the Representative has only viewing rights on the catalogs and cannot buy products/services from the catalogs. The Representative also has access to the profiles of the Organizations in his portfolio. In one embodiment, the Representative has only viewing rights (no edit/modify rights) to an Organization's basic profile 946 and creating, editing/modifying rights for an Organization's market profile 947. Persons of ordinary skill in the art should appreciate that the market profiles, created by the Representative, get appended to the Organization's basic profile.

The above examples are merely illustrative of the many applications of the e-commerce system of present invention. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

1. A computer implemented method for enabling an e-commerce system, represented virtually by an administrator, for the sale of goods and/or services between a plurality of sellers and individual customers, who identify themselves to be affiliates of at least one of a plurality of Organizations, the method comprising the steps of:
a. online registration of the plurality of Organizations who intend to facilitate cost savings for their members and also benefit from fundraising opportunities through the e-commerce system;
b. online registration, and affiliation (to at least one Organization) of the customers who intend to use the e-commerce system for purchasing goods and/or services collectively, to realize cost savings and also help raise charitable funds for the Organization that they are affiliated to;
c. online referral of new (not yet registered) Organizations by customers to the administrator;
d. online formation of a virtual Organization, initiated by a customer, when an Organization of choice does not exist on the e-commerce system; followed by invitation by the customer to other customers to become members of the newly formed virtual Organization to attain minimum membership for the virtual Organization;
e. nomination, selection or identification of Org Head for each Organization;
f. identification and selection of an appropriate ad hoc distribution facility, based upon availability of ad hoc distribution facilities operated by third-parties, for each Organization;
g. online registration of the plurality of sellers, who intend to sell goods and/or services to registered members (customers), with the approval of their respective Organizations and with a pre-determined charitable benefit to the Organizations;
h. online electronic publishing of a catalog comprising an offer to sell goods and/or services by a seller, the said catalog being characterized by at least a catalog period, method of delivering the goods and/or services, and a pledge to donate a pre-determined proportion of sales proceeds to concerned Organizations;
i. online selection, by the registered sellers, of registered Organizations to be participants and beneficiaries of the said catalog;
j. referral of the said catalog to the selected Organizations, by an Administrator of the e-commerce system, and follow-up for electronic acceptance of the said catalog by the selected Organizations;
k. electronic acceptance (or non-acceptance) of the said catalog by the selected Organizations and electronic referral of the said catalog along with the said catalog characteristics to the plurality of customers affiliated with the selected Organizations;
l. online purchase, by the said plurality of customers, of goods and/or services offered in the said catalog by the seller;
m. compilation and processing, by the e-commerce system, of online purchases and electronic communication of resultant order data, delivery and distribution instructions to the seller; and
n. electronic calculation and release of funds, automatically, to the seller and the Organizations based on a predetermined apportioning method.

2. The method of claim 1, wherein the catalog is a Campus Catalog.

3. The method of claim 1, wherein the catalog is a Direct Catalog.

4. The method of claim 1, wherein the catalog is a Soft Catalog.

5. The method of claim 1, wherein electronic mail notifications are automatically sent to the customers affiliated to Organizations when their respective Organizations accept a catalog.

6. The method of claim 5, wherein in addition to electronic mail notifications, printed paper notifications are made available for distribution to the customers affiliated to the Organizations.

7. The method of claim 1, wherein consumers can view online, the details and content of the said catalog at any time after acceptance of the said catalog by their respective Organizations, but can make actual purchases only during the Catalog Period.

8. The method of claim 1, wherein funds received from the customers, as a result of purchase transactions, are held in escrow until deliveries of goods and/or services are performed by the sellers.

9. The method of claim 1, wherein the e-commerce system allows registration of voluntary or compensated Field Representatives and assigns them to specific Organizations.

10. The method of claim 9, wherein the Field Representatives can add or update a Market Profile to the registered Organizations assigned to them.

11. The method of claim 1, wherein according to the purchases the customers are alerted with automatic electronic mail notifications of shipment data.

12. The method of claim 1, wherein an Org Head is designated to receive deliveries of products/services on behalf of customers/members, affiliated to the Organization, who make the purchases, thereby the Org Head and customers releasing the e-commerce system of any liabilities.

13. The method of claim 1, wherein the customers can electronically affiliate themselves to more than one Organization, or delete (end affiliation with) current Organizations.

14. The method of claim 1, wherein the said catalog is subject to review, revision and approval by the Administrator, before it is assigned to Organizations.

15. The method of claim 10, wherein the seller is provided access to database of registered Organizations through the Basic and Market Profile data filters, to enable the seller to review database results obtained based on said filters and thereby select the Organizations that are most suitable for their catalogs.

16. The method of claim 1, wherein the funds released to the seller comprise of guaranteed manufacturers cost (GMC) and also whole or portion of escrowed shipping funds (ESF) reserved for mitigating the seller's risk of higher delivery costs resulting from insufficient purchase volumes by the customers in case of Campus Catalogs.

17. The method of claim 1, wherein the funds released to the Organizations may comprise predetermined charitable funds or donations (GFO).

18. The method of claims 1 and 9, wherein the funds released to the Field Representatives comprise a predetermined Field Representative Commission (RCF).

19. A method, implemented in an e-commerce system, of mitigating a seller's risk of higher delivery costs resulting from insufficient volumes of products and/or services ordered by customers affiliated to an Organization; the method comprising the steps of:
a. establishing a desired average volume per Organization for delivery of goods and/or services;
b. establishing a price of goods and/or services including delivery cost;
c. establishing a catalog period;
d. establishing reserve funds as a percentage of total actual sales to be held in escrow to compensate the seller for higher delivery costs resulting from insufficient volumes of products and/or services ordered during the catalog period; and
e. distributing the reserve funds to the seller and/or the Organization based on an apportioning method.

20. The method of claim 19, wherein a predetermined portion of said price of goods and/or services is guaranteed to be paid to the seller as Guaranteed Manufacturer's Cost (GMC).

21. The method of claim 19, wherein the said desired average volume per Organization is predetermined and termed as Guaranteed Average Volume (GAV).

22. The method of claim 19, wherein the said reserve funds as a percentage of total actual sales to be held in escrow is predetermined and termed as Escrowed Shipping Funds (ESF).

23. The method of claims 1, 21 and 22 wherein a Shipping Allowance Factor (SAF) is pre-determined for the purpose of implementing the apportioning method and for specifying how the ESF would be allocated based on whether or not GAV is achieved in actual transactions.

24. The method of claim 19, wherein if purchases of goods and/or services are made, then based on an Actual Shipping Value (ASV), the apportioning method comprises the steps of:
a. determining if the Actual Shipping Value (ASV) meets, exceeds or falls short of a Guaranteed Average Volume (GAV); and b) determining
i. if ASV meets or exceeds GAV, then allocating the reserve funds equivalent to ASV*ESF as donation (in addition to GFO) to the Organization, wherein the ESF is predetermined Escrowed Shipping Funds;
ii. if ASV<GAV, but, >(GAV−(GAV*SAF %)) then releasing the reserve funds equivalent to {(GAV−ASV)/(GAV*SAF %)}*(ASV*ESF %) to the seller and funds equivalent to (ASV*ESF %) [1−{(GAV−ASV)/(GAV*SAF %)}] as donations to the Organization; or
iii. if ASV≦(GAV−(GAV*SAF %)) then releasing the reserve funds equivalent to ASV*ESF % to the seller and no funds as donations to the Organization.

25. The method of claims 17 and 24, wherein certain funds, predetermined as Guaranteed Funds to Organizations (GFO), as donations are guaranteed to the Organization even if the ASV falls short of the GAV.

26. The method of claim 19, wherein a predetermined portion of said price of goods and/or services is retained as processing cost (PRC) by the e-commerce system.

27. The method of claim 24, wherein any or all of the following exceptions are made with regards to final allocation or disbursement of funds accumulated in ESF:
a. all funds allocated (out of ESF) to Seller or Organization(s) can be held further in escrow until Catalog becomes “Closed Catalog” and all returns and exchanges are resolved;
b. funds allocated (out of ESF) to Organization(s) may be retained by Administrator as discretionary funds to meet marketing expenses related to promoting business with those Organization(s); and/or
c. funds allocated (out of ESF) to Organization(s) may be re-routed and distributed to Customers (as rebates) or to Field Reps (as performance incentives).

28. The method of claim 19, wherein customers can establish direct or indirect affiliation or membership with Organization(s); and wherein an indirect membership requires identifying Alias on the e-commerce system.

29. The method of claim 19, wherein customers desirous of purchasing add out of stock items can add the said items to a Wish-List; thereby also causing the e-commerce system to periodically and automatically notifying relevant seller of the aggregated Wish-List.

30. The method of claim 29, wherein once the seller adds a Wish-List item back to inventory, the said item becomes in-stock again and the concerned customers are automatically notified.

31. The method of claim 30, wherein once the customer purchases the in-stock item, the said item is then removed from the customer's Wish-List.

32. The method of claim 12, wherein the Org Head tracks and confirms receipt of products/services, real-time, using mobile messaging applications.

33. The method of claim 1 and claim 19, wherein the release of funds can be tracked, real-time, by the sellers, Organizations and Field Representatives.
